(19) United States
(12) Patent Application Publication
(10) Pub. No.: US 2026/0181746 A1
(43) Pub. Date: Jun. 25, 2026

(54) CERAMIC HEATER

(71) Applicant: NGK INSULATORS, LTD., Nagoya-shi (JP)

(72) Inventors: Yutaka UNNO, Handa-shi (JP); Kentaro KIMURA, Handa-shi (JP); Yoshinobu GOTO, Nagoya-shi (JP)

(73) Assignee: NGK INSULATORS, LTD., Nagoya-shi (JP)

(21) Appl. No.: 19/546,642

(22) Filed: Feb. 23, 2026

Related U.S. Application Data
(63) Continuation of application No. PCT/JP2025/022422, filed on Jun. 20, 2025.

(30) Foreign Application Priority Data
Jul. 18, 2024 (JP) 2024-115293
Dec. 25, 2024 (WO) PCT/JP2024/046003

(51) Int. Cl. H05B 3/28; H05B 3/00

(52) U.S. Cl. CPC H05B 3/283; H05B 3/0019; H05B 2203/012; H05B 2203/016

(57) ABSTRACT

There is provided a ceramic heater including: a ceramic plate including a first surface, and a second surface; a first RF/ESC electrode embedded in the ceramic plate; a second RF/ESC electrode electrically connected to the first RF/ESC electrode, and embedded at a depth position farther from the first surface than the first RF/ESC electrode; an RF/ESC rod including one end electrically connected to the second RF/ESC electrode; an RF/ESC terminal hole being a bottomed hole into which a front end part of the RF/ESC rod is inserted; and a heater circuit embedded at a depth position closer to the second surface than the second RF/ESC electrode. A distance between a center line of the first RF/ESC electrode and that of the second RF/ESC electrode is 2 to 7 mm. A distance from the first surface to a hole bottom of the RF/ESC terminal hole is 4 to 9 mm.

### CROSS-REFERENCE TO RELATED APPLICATIONS

This application is a continuation application of PCT/JP2025/022422 filed Jun. 20, 2025, which claims priority to Japanese Patent Application No. 2024-115293 filed Jul. 18, 2024 and PCT/JP2024/046003 filed Dec. 25, 2024, the entire contents all of which are incorporated herein by reference.

### BACKGROUND OF THE INVENTION

### 1. Field of the Invention

The present disclosure relates to a ceramic heater.

### 2. Description of the Related Art

In a film forming apparatus and an etching apparatus for a semiconductor manufacturing process, a ceramic heater is used as a support stage for uniformly controlling a temperature of a wafer. As such a ceramic heater, a ceramic heater that includes a ceramic plate on which the wafer is to be placed, and a cylindrical ceramic shaft attached to the ceramic plate is widely used. The ceramic plate generally includes a configuration in which internal electrodes such as an RF electrode and/or electrostatic chuck (ESC) electrode (hereinafter, referred to as RF/ESC electrode), and a heater electrode are embedded inside a ceramic substrate made of aluminum nitride (AlN) or the like that is excellent in heat resistance and corrosion resistance.

Patent Literature 1 (JP6773917B) discloses a wafer support in which an RF electrode and a heater electrode are embedded inside a disk-shaped ceramic substrate having a wafer placement surface. In the wafer placement table, the RF electrode is composed of a plurality of RF zone electrodes that are individually disposed for each of a plurality of divided zones of the wafer placement surface. The plurality of RF zone electrodes are separately disposed in at least two stages that are positioned at different distances from the wafer placement surface. The plurality of RF zone electrodes are independently connected to a plurality of RF zone electrode conductors through electrode terminals provided on a bottom surface of the ceramic substrate.

Patent Literature 2 (JP2023-87447A) discloses a wafer placement table that includes a ceramic substrate having a wafer placement surface, a first electric conductive layer and a second electric conductive layer embedded at different levels in the ceramic substrate, and a conductor unit that establishes electric continuity between the first electric conductive layer and the second electric conductive layer. The conductor unit is a transversely placed coil or a transversely placed perforated cylindrical body.

Patent Literature 3 (JP6530878B) discloses a wafer placement table that includes a ceramic substrate having a wafer placement surface, a first electrode and a second electrode embedded at different levels in the ceramic substrate in parallel with the wafer placement surface, and a conductive section electrically conducting the first electrode and the second electrode. The conductive section is obtained by laminating a plurality of plate-shaped metal meshes parallel to the wafer placement surface.

### CITATION LIST

### Patent Literature

Patent Literature 1: JP6773917B
Patent Literature 2: JP2023-87447A
Patent Literature 3: JP6530878B

### SUMMARY OF THE INVENTION

Along with miniaturization and high integration of a semiconductor manufacturing process in recent years, various kinds of use conditions of a ceramic heater have tended to be tightened. For example, a temperature of the process is increased (for example, 700° C. or more), RF power is increased (for example, 2 KW or more), and an RF frequency is increased (for example, 27 MHz or more). Along therewith, precise control of a wafer temperature (in particular, the temperature of the wafer outer peripheral part) is necessary. In this regard, uniformization of plasma distribution has been performed; however, in-plane temperature uniformity required for the ceramic heater is being tightened.

In execution of the semiconductor manufacturing process, individual tuning for each process condition is normally performed. For example, a process such as film formation is often performed in a state where, to increase the temperature of the wafer outer peripheral part that is easily reduced due to influence of a chamber environment, a plate surface of the ceramic heater is set to have temperature distribution in which the outer peripheral part is relatively high in temperature (so-called periphery-hot temperature distribution), in other words, temperature distribution in which a center part is relatively low in temperature (so-called center-cool temperature distribution). In the ceramic heater with a ceramic shaft, a plurality of terminals and terminal holes are intensively arranged at the center part of the ceramic plate on which the wafer is placed, because of the structure. In this case, when the ceramic heater has the center-cool temperature distribution, excessive tensile stress may occur on the terminal holes of the ceramic plate. In particular, stress easily concentrates on a terminal hole for an RF/ESC electrode (hereinafter, referred to as RF/ESC terminal hole) that is formed relatively deeper than the other terminal holes, and therefore, the ceramic heater is easily broken near the RF/ESC terminal hole. In this regard, to avoid stress concentration, the RF/ESC terminal hole may be made shallow. In this case, however, a depth of the RF/ESC electrode from the wafer placement surface of the ceramic plate is increased. Thus, impedance is increased to largely adversely affect control of plasma by the RF electrode or to deteriorate a wafer catching function by the ESC electrode. Therefore, it is desirable to provide the ceramic heater in which breakage attributable to center-cool temperature distribution is less likely to occur while functions of the RF/ESC electrode (namely, plasma control function and/or wafer chucking function) are not impaired.

The present inventors have now found that by (i) adopting an RF/ESC electrode structure of a two-layer structure including a first RF/ESC electrode and a second RF/ESC electrode that are electrically connected to each other and arranged in parallel with each other, (ii) setting a distance between a center line of the first RF/ESC electrode and a center line of the second RF/ESC electrode to 2 mm to 7 mm, and (iii) setting a distance from a wafer placement surface of a ceramic plate to a hole bottom of an RF/ESC terminal hole to 4 mm to 9 mm, it is possible to provide the ceramic heater in which breakage attributable to center-cool temperature distribution is less likely to occur while functions of the RF/ESC electrode are not impaired. Further, the present inventors have also found that, even in a case where the second RF/ESC electrode is not used, by (i) adopting an RF/ESC electrode structure including the first RF/ESC electrode and an embedded member that are electrically connected to each other through a connection member such as a coil, (ii) setting a separation distance between the first RF/ESC electrode and the embedded member to 1 mm to 7 mm, and (iii) setting a distance from the wafer placement surface of the ceramic plate to a hole bottom of an RF/ESC terminal hole to 2 mm to 16 mm, it is possible to provide the ceramic heater that has a relatively simple structure not including the second RF/ESC electrode and in which breakage attributable to center-cool temperature distribution is less likely to occur while functions of the RF/ESC electrode are not impaired, similarly to the above.

Therefore, an object of the present invention is to provide a ceramic heater in which breakage attributable to center-cool temperature distribution is less likely to occur while functions of the RF/ESC electrode are not impaired.

The present disclosure provides the following aspects.

### Aspect 1

A ceramic heater, comprising:
a ceramic plate including a first surface on which a wafer is to be placed, and a second surface opposite to the first surface;
a first RF/ESC electrode embedded in the ceramic plate in parallel with the first surface;
a second RF/ESC electrode electrically connected to the first RF/ESC electrode, and embedded at a depth position farther from the first surface than the first RF/ESC electrode in the ceramic plate in parallel with the first surface;
an RF/ESC rod including one end electrically connected to the second RF/ESC electrode, and another end extending from the second surface to an outside of the ceramic plate;
an RF/ESC terminal hole into which a front end part of the RF/ESC rod is inserted, the RF/ESC terminal hole being a bottomed hole provided in a thickness direction from the second surface of the ceramic plate toward the second RF/ESC electrode; and
a heater circuit embedded at a depth position closer to the second surface than the second RF/ESC electrode in the ceramic plate,
wherein a distance between a center line of the first RF/ESC electrode and a center line of the second RF/ESC electrode is 2 mm to 7 mm, and
wherein a distance from the first surface to a hole bottom of the RF/ESC terminal hole is 4 mm to 9 mm.

### Aspect 2

A ceramic heater, comprising:
a ceramic plate including a first surface on which a wafer is to be placed, and a second surface opposite to the first surface;
a first RF/ESC electrode embedded in the ceramic plate in parallel with the first surface;
an embedded member embedded at a depth position farther from the first surface than the first RF/ESC electrode in the ceramic plate;
a connection member embedded between the first RF/ESC electrode and the embedded member in the ceramic plate, and configured to electrically connect the first RF/ESC electrode and the embedded member;
an RF/ESC rod including one end electrically connected to the embedded member, and another end extending from the second surface to an outside of the ceramic plate;
an RF/ESC terminal hole into which a front end part of the RF/ESC rod is inserted, the RF/ESC terminal hole being a bottomed hole provided in a thickness direction from the second surface of the ceramic plate toward the embedded member; and
a heater circuit embedded at a depth position closer to the second surface than the embedded member in the ceramic plate,
wherein a separation distance between the first RF/ESC electrode and the embedded member is 1 mm to 7 mm, and
wherein a distance from the first surface to a hole bottom of the RF/ESC terminal hole is 2 mm to 16 mm.

### Aspect 3

The ceramic heater according to aspect 1, further comprising a connection member configured to electrically connect the first RF/ESC electrode and the second RF/ESC electrode, between the first RF/ESC electrode and the second RF/ESC electrode in the ceramic plate.

### Aspect 4

The ceramic heater according to aspect 2 or 3, wherein the connection member is at least one selected from the group consisting of a coil, a metal tablet, and a metal mesh laminate.

### Aspect 5

The ceramic heater according to any one of aspects 1 to 4 wherein the ceramic plate contains aluminum nitride or aluminum oxide.

### Aspect 6

The ceramic heater according to any one of aspect 1 and 3 to 5, wherein the first RF/ESC electrode and/or the second RF/ESC electrode contains at least one selected from the group consisting of tungsten, molybdenum, a tungsten-molybdenum alloy, tungsten carbide, a tungsten carbide-titanium nitride composite material, a tungsten carbide-aluminum oxide composite material, and niobium.

### Aspect 7

The ceramic heater according to any one of aspects 1 to 6, wherein the first RF/ESC electrode contains at least one selected from the group consisting of tungsten, molybdenum, a tungsten-molybdenum alloy, tungsten carbide, a tungsten carbide-titanium nitride composite material, a tungsten carbide-aluminum oxide composite material, and niobium.

### Aspect 8

The ceramic heater according to any one of aspect 2 to 7, wherein the connection member contains at least one selected from the group consisting of tungsten, molybdenum, a tungsten-molybdenum alloy, tungsten carbide, a tungsten carbide-titanium nitride composite material, a tungsten carbide-aluminum oxide composite material, and niobium.

### Aspect 9

The ceramic heater according to any one of aspects 2 to 8, wherein when the ceramic plate is viewed from above, the connection member is disposed at a position at least partially overlapping with the RF/ESC terminal hole.

### Aspect 10

The ceramic heater according to any one of aspects 2 to 8, wherein when the ceramic plate is viewed from above, the connection member is disposed at a position not overlapping with the RF/ESC terminal hole.

### Aspect 11

The ceramic heater according to any one of aspects 1 to 10, further comprising a ceramic shaft attached to the second surface of the ceramic plate and having a cylindrical shape including an internal space.

### Aspect 12

The ceramic heater according to any one of aspects 1, 3 to 5 and 7 to 11, wherein, in a plan view, the first RF/ESC electrode has a disk shape, and the second RF/ESC electrode has a disk shape or a combined shape of an annular portion and a linear portion.

### Aspect 13

The ceramic heater according to any one of aspects 1 to 11, wherein, in a plan view, the first RF/ESC electrode has a disk shape.

### Aspect 14

The ceramic heater according to any one of aspects 1, 3 to 5 and 7 to 13, wherein each of the first RF/ESC electrode and the second RF/ESC electrode has at least one form selected from the group consisting of a mesh, a perforated metal, and a printed pattern.

### Aspect 15

The ceramic heater according to any one of aspects 1 to 14, wherein the first RF/ESC electrode has at least one form selected from the group consisting of a mesh, a perforated metal, and a printed pattern.

### Aspect 16

The ceramic heater according to any one of aspects 1 to 15, further comprising a heater rod including one end electrically connected to the heater circuit, and another end extending from the second surface to the outside of the ceramic plate.

### Aspect 17

The ceramic heater according to any one of aspects 1, 3 to 5 and 7 to 14, further comprising an embedded member embedded between the hole bottom of the RF/ESC terminal hole and the second RF/ESC electrode in the ceramic plate, and configured to electrically connect the RF/ESC rod and the second RF/ESC electrode.

### BRIEF DESCRIPTION OF THE DRAWINGS

FIG. 1 is a perspective top view schematically illustrating an example of a ceramic heater according to a first aspect of the present invention, and corresponds to Example A1.

FIG. 2 is a schematic cross-sectional view illustrating the ceramic heater illustrated in FIG. 1.

FIG. 3 is a schematic cross-sectional view conceptually illustrating an internal structure of a ceramic plate in the ceramic heater illustrated in FIG. 1.

FIG. 4 is a perspective top view schematically illustrating another example of the ceramic heater according to the present invention, and corresponds to Example A2.

FIG. 5 is a schematic cross-sectional view illustrating the ceramic heater illustrated in FIG. 4.

FIG. 6 is a schematic cross-sectional view conceptually illustrating an internal structure of a ceramic plate in the ceramic heater illustrated in FIG. 4.

FIG. 7 is a perspective top view schematically illustrating another example of the ceramic heater according to the first aspect of the present invention, and corresponds to Example A3.

FIG. 8 is a schematic cross-sectional view illustrating the ceramic heater illustrated in FIG. 7.

FIG. 9 is a schematic cross-sectional view conceptually illustrating an internal structure of a ceramic plate in the ceramic heater illustrated in FIG. 7.

FIG. 10 is a perspective top view schematically illustrating another example of the ceramic heater according to the first aspect of the present invention, and corresponds to Example A4.

FIG. 11 is a schematic cross-sectional view illustrating the ceramic heater illustrated in FIG. 10.

FIG. 12 is a schematic cross-sectional view conceptually illustrating an internal structure of a ceramic plate in the ceramic heater illustrated in FIG. 10.

FIG. 13 is a perspective top view schematically illustrating an example of an existing ceramic heater, and corresponds to Example A5 (comparative example).

FIG. 14 is a schematic cross-sectional view illustrating the ceramic heater illustrated in FIG. 13.

FIG. 15 is a schematic cross-sectional view conceptually illustrating an internal structure of a ceramic plate in the ceramic heater illustrated in FIG. 13.

FIG. 16 is a perspective top view schematically illustrating another example of the existing ceramic heater, and corresponds to Example A6 (comparative example).

FIG. 17 is a schematic cross-sectional view illustrating the ceramic heater illustrated in FIG. 16.

FIG. 18 is a schematic cross-sectional view conceptually illustrating an internal structure of a ceramic plate in the ceramic heater illustrated in FIG. 16.

FIG. 19 is a schematic cross-sectional view illustrating one aspect of positional relationship between a connection member and an RF/ESC terminal hole in the ceramic heater according to the first aspect of the present invention.

FIG. 20 is a schematic cross-sectional view illustrating an example of the positional relationship between the connection member and the RF/ESC terminal hole in the aspect illustrated in FIG. 19.

FIG. 21 is a schematic cross-sectional view illustrating another example of the positional relationship between the connection member and the RF/ESC terminal hole in the aspect illustrated in FIG. 19.

FIG. 22 is a schematic cross-sectional view illustrating another aspect of the positional relationship between the connection member and the RF/ESC terminal hole in the ceramic heater according to the first aspect of the present invention.

FIG. 23 is a schematic top view illustrating an arrangement example of the connection member in the aspect illustrated in FIG. 22. A cross-section taken along line A-A of a configuration illustrated in FIG. 23 corresponds to FIG. 22.

FIG. 24 is a schematic top view illustrating another arrangement example of the connection member in the aspect illustrated in FIG. 22. A cross-section taken along line A-A of a configuration illustrated in FIG. 24 corresponds to FIG. 22.

FIG. 25 is a schematic top view illustrating another arrangement example of the connection member in the aspect illustrated in FIG. 22. A cross-section taken along line A-A of a configuration illustrated in FIG. 25 corresponds to FIG. 22.

FIG. 26 is a perspective top view schematically illustrating another example of a ceramic heater according to a second aspect of the present invention.

FIG. 27 is a schematic cross-sectional view illustrating the ceramic heater illustrated in FIG. 26.

FIG. 28 is a schematic cross-sectional view conceptually illustrating an internal structure of a ceramic plate in the ceramic heater illustrated in FIG. 26.

FIG. 29 is a schematic cross-sectional view illustrating another example of a configuration of a connection member and an embedded member in the ceramic heater illustrated in FIG. 26.

FIG. 30 is a schematic cross-sectional view illustrating another example of the configuration of the connection member and the embedded member in the ceramic heater illustrated in FIG. 26.

FIG. 31 is a schematic cross-sectional view illustrating another example of the configuration of the connection member and the embedded member in the ceramic heater illustrated in FIG. 26.

### DETAILED DESCRIPTION OF THE INVENTION

A ceramic heater according to the present invention is a table made of ceramic, for supporting a wafer in a semiconductor manufacturing apparatus. Typically, the ceramic heater according to the present invention may be a ceramic heater for a semiconductor film forming apparatus. Typical examples of the film forming apparatus include a CVD (chemical vapor deposition) apparatus (for example, thermal CVD apparatus, plasma CVD apparatus, optical CVD apparatus, and MOCVD apparatus) and a PVD (physical vapor deposition) apparatus.

### (Ceramic Heater According to First Aspect)

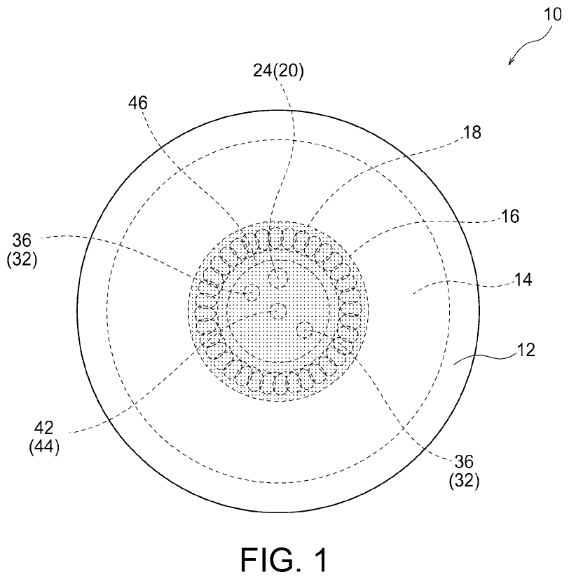

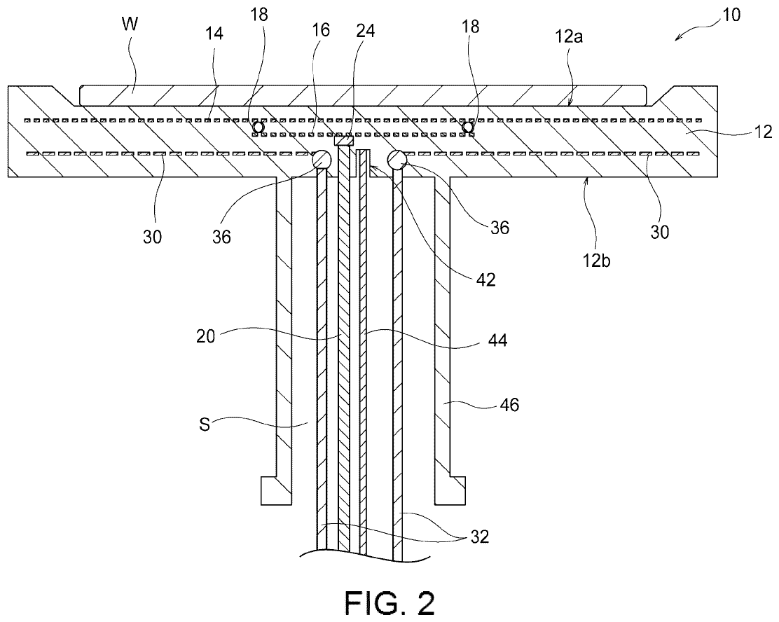

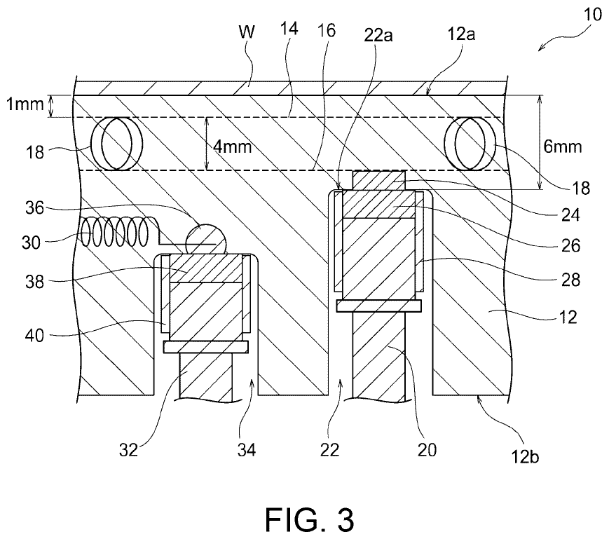

A ceramic heater according to a first aspect of the present invention adopts an RF/ESC electrode structure of a two-layer structure including a first RF/ESC electrode and a second RF/ESC electrode. FIGS. 1 to 3 illustrate one aspect of such a ceramic heater. A ceramic heater 10 illustrated in FIGS. 1 and 2 includes a ceramic plate 12, a first RF/ESC electrode 14, a second RF/ESC electrode 16, an RF/ESC rod 20, an RF/ESC terminal hole 22, and a heater circuit 30. The ceramic plate 12 includes a first surface 12a on which a wafer W is placed, and a second surface 12b opposite to the first surface 12a. The first RF/ESC electrode 14 is embedded in the ceramic plate 12 in parallel with the first surface 12a. The second RF/ESC electrode 16 is electrically connected to the first RF/ESC electrode 14, and is embedded at a depth position farther from the first surface 12a than the first RF/ESC electrode 14 in the ceramic plate 12 in parallel with the first surface 12a. The RF/ESC rod 20 includes one end electrically connected to the second RF/ESC electrode 16, and the other end extending from the second surface 12b to an outside of the ceramic plate 12. The RF/ESC terminal hole 22 is a bottomed hole provided in a thickness direction from the second surface 12b of the ceramic plate 12 toward the second RF/ESC electrode 16, and a front end part of the RF/ESC rod 20 is inserted into the RF/ESC terminal hole 22. The heater circuit 30 is embedded at a depth position closer to the second surface 12b than the second RF/ESC electrode 16 in the ceramic plate 12. A distance between a center line of the first RF/ESC electrode 14 and a center line of the second RF/ESC electrode 16 is 2 mm to 7 mm. A distance from the first surface 12a to a hole bottom 22a of the RF/ESC terminal hole 22 is 4 mm to 9 mm. Thus, by (i) adopting the RF/ESC electrode structure of the two-layer structure including the first RF/ESC electrode 14 and the second RF/ESC electrode 16 that are electrically connected to each other and arranged in parallel with each other, (ii) setting the distance between the center line of the first RF/ESC electrode 14 and the center line of the second RF/ESC electrode 16 to 2 mm to 7 mm, and (iii) setting the distance from the first surface 12a of the ceramic plate 12 to the hole bottom 22a of the RF/ESC terminal hole 22 to 4 mm to 9 mm, it is possible to provide the ceramic heater 10 in which breakage attributable to center-cool temperature distribution is less likely to occur while functions of the RF/ESC electrode 14 are not impaired.

As described above, in a case where a plurality of terminals and terminal holes are collectively arranged at a center part of the ceramic plate on which the wafer is placed, when the ceramic heater has the center-cool temperature distribution, excessive tensile stress may occur on the terminal holes of the ceramic plate. In particular, stress easily concentrates on the RF/ESC terminal hole that is formed relatively deeper than the other terminal holes, and therefore, the ceramic heater is easily broken near the RF/ESC terminal hole. In other words, in the case of periphery-hot or center-cool temperature distribution, thermal expansion on a plate outer peripheral part is relatively greater than thermal expansion on a plate center part. Thus, tensile stress occurs in a radius direction in a form in which the plate outer periphery part pulls the plate center part, and the tensile stress is applied to the RF/ESC terminal hole positioned at the plate center part. As generally known, a stress concentration factor is increased as the hole is deeper. Therefore, stress easily concentrates on the RF/ESC terminal hole formed deep. In this regard, to avoid stress concentration, the RF/ESC terminal hole may be made shallow. In this case, however, a depth of the RF/ESC electrode from a wafer placement surface of the ceramic plate is increased (for example, from 1 mm to 3 mm). Thus, impedance is increased to largely adversely affect control of plasma by the RF electrode or to deteriorate a wafer chucking function by the ESC electrode. The present invention successfully solves these problems. In the present invention, the RF/ESC electrode structure of the two-layer structure including the first RF/ESC electrode 14 and the second RF/ESC electrode 16 that are arranged separately from each other and arranged in parallel with each other is adopted. In the two-layer structure, the first RF/ESC electrode 14 can be disposed at a shallow position near the first surface 12a as with the existing RF/ESC electrode, and the second RF/ESC electrode 16 (electrically connected to first RF/ESC electrode 14) is disposed at a position deeper than the position of the first RF/ESC electrode 14 (with first surface 12a as reference), which makes it possible to secure electric connection with the RF/ESC rod 20. In other words, the desired RF/ESC electrode function can be secured by the first RF/ESC electrode 14 as with the existing technique, and the second RF/ESC electrode 16 for electric connection is disposed at a deeper position, which makes it possible to make the RF/ESC terminal hole 22 shallower than an existing product (that is, hole bottom 22a of RF/ESC terminal hole 22 can be brought closer to second surface 12b). Stress is less likely to concentrate on the RF/ESC terminal hole 22 thus formed shallow, and accordingly, the ceramic heater 10 is less likely to be broken near the RF/ESC terminal hole 22.

In the ceramic plate 12, a main portion (namely, ceramic substrate) other than various kinds of embedded members such as the first RF/ESC electrode 14, the second RF/ESC electrode 16, a connection member 18, and the heater circuit 30 preferably contains aluminum nitride or aluminum oxide, and more preferably contains aluminum nitride in terms of excellent heat conductivity, high electric insulating property, thermal expansion characteristics close to silicon, and the like.

The ceramic plate 12 preferably has a disk shape. However, a plan-view shape of the ceramic plate 12 having the disk shape is not required to be a complete circular shape, and may be an incomplete circular shape partially lacked, such as orientation flat. A size of the ceramic plate 12 may be appropriately determined based on a diameter of a wafer assumed to be used, and is not particularly limited. In a case of the circular shape, a diameter of the ceramic plate 12 is typically 150 mm to 450 mm, and in particular, a diameter of the ceramic plate 12 for 300 mm silicon wafer is typically 320 mm to 380 mm. A thickness of the ceramic plate 12 is typically 10 mm to 25 mm.

The first RF/ESC electrode 14 is defined as an RF electrode and/or an ESC electrode that is embedded at a depth position closer to the first surface 12a than the second RF/ESC electrode 16 in the ceramic plate 12 in parallel with the first surface 12a. In a plan view, the first RF/ESC electrode 14 is preferably provided so as to include a main region of the ceramic plate 12 where the wafer W is to be placed. The RF electrode enables film formation by a plasma CVD process by receiving high frequency waves. The ESC electrode is an abbreviation for an electrostatic chuck (ESC) electrode, and is also referred to as an electrostatic electrode. Upon receiving a voltage from an external power supply, the ESC electrode chucks the wafer W placed on a top surface of the ceramic plate 12 with Johnson-Rahbek force. The ESC electrode is preferably a circular thin-layer electrode slightly smaller in diameter than the ceramic plate 12, and may be, for example, a sheet-like mesh electrode formed by weaving thin metal wires in a mesh pattern. The ESC electrode may be used as a plasma electrode. In other words, when high frequency waves are applied to the ESC electrode, the ESC electrode can also be used as the RF electrode, and film formation by a plasma CVD process can also be performed. To sufficiently exert the functions as the RF/ESC electrode, a distance from the first surface 12a to the first RF/ESC electrode 14 is preferably 0.8 mm to 2.5 mm, more preferably 0.9 mm to 2.0 mm, and further preferably 1.0 mm to 1.5 mm.

The second RF/ESC electrode 16 is defined as an RF electrode and/or an ESC electrode that is electrically connected to the first RF/ESC electrode 14 and is embedded at a depth position farther from the first surface 12a than the first RF/ESC electrode 14 in the ceramic plate 12 in parallel with the first surface 12a. In a plan view, the second RF/ESC electrode 16 is preferably provided so as to overlap with or be included in the first RF/ESC electrode 14. The functions as the RF/ESC electrode in the RF/ESC electrode structure of the two-layer structure are mainly born by the first RF/ESC electrode 14. Therefore, it is little expected that the second RF/ESC electrode 16 itself functions as the RF/ESC electrode, and the second RF/ESC electrode 16 functions as a conductive member that secures electric connection with the RF/ESC rod 20 at a position deeper than the position of the first RF/ESC electrode 14 to supply power to the first RF/ESC electrode 14. Therefore, the RF/ESC rod 20 for power supply is electrically connected to the second RF/ESC electrode 16 (optionally through embedded member 24 and/or buffer 26 and/or eyelet 28). The second RF/ESC electrode 16 is connected to an external power supply (not illustrated) through the RF/ESC rod 20. Although not particularly limited, preferable examples of a metal configuring the RF/ESC rod 20 include Ni, W, Mo, and a joint structure of Ni and W, and W or Mo that is a paramagnetic material having relatively small impedance is more preferable.

As a secondary effect by adoption of the RF/ESC electrode structure of the two-layer structure, an RF capture rate is enhanced by the two RF/ESC electrodes 14 and 16, and accordingly, an effect of reducing transmission of the RF high frequency waves, and reducing RF noise to the heater circuit 30 can be obtained. In other words, an effect of reducing an RF current flowing into the heater circuit 30 can be obtained. While increase in the RF frequency is assumed as a future trend, there is a tendency that RF high frequency waves easily pass through the RF electrode as the frequency is increased. In this regard, by addition of the second RF/ESC electrode 16, an effect of reducing the RF current to the heater circuit 30 by reduction of the RF noise can be expected.

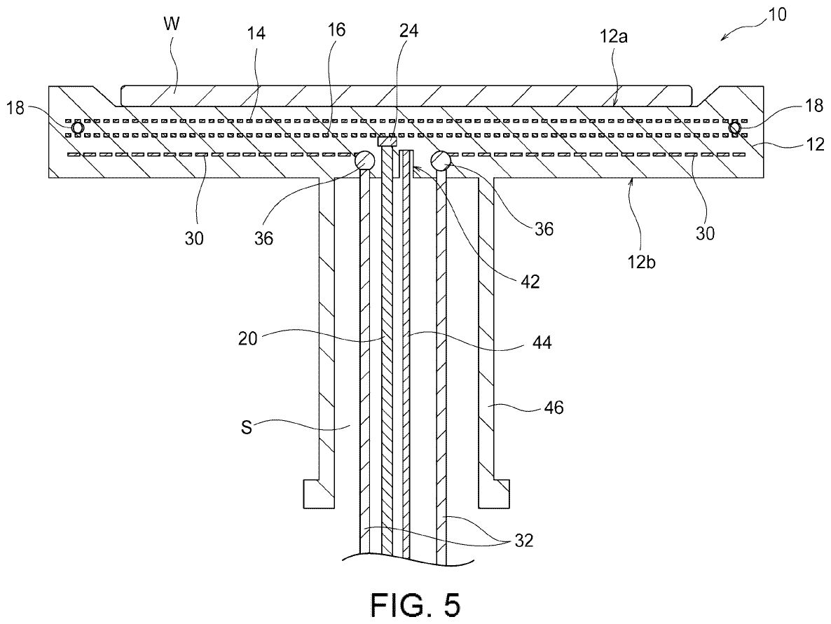

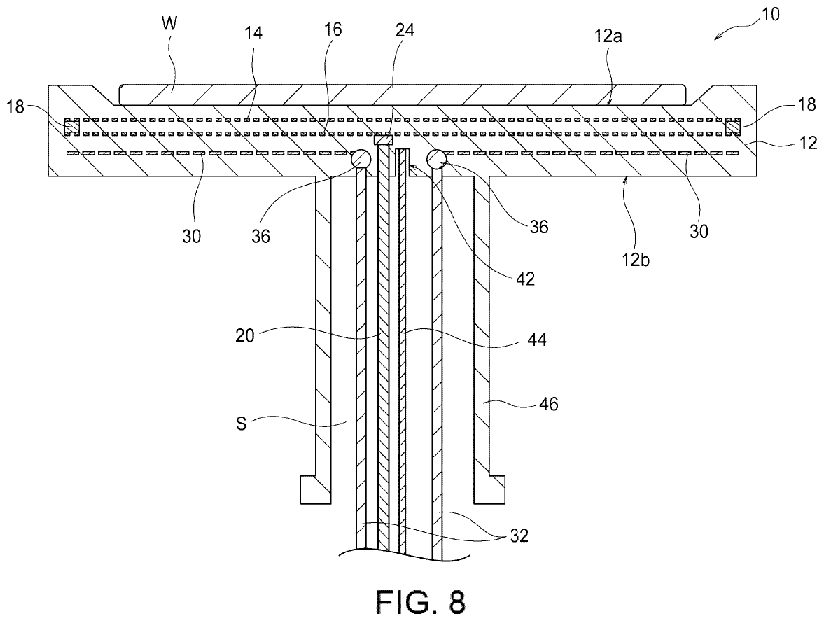

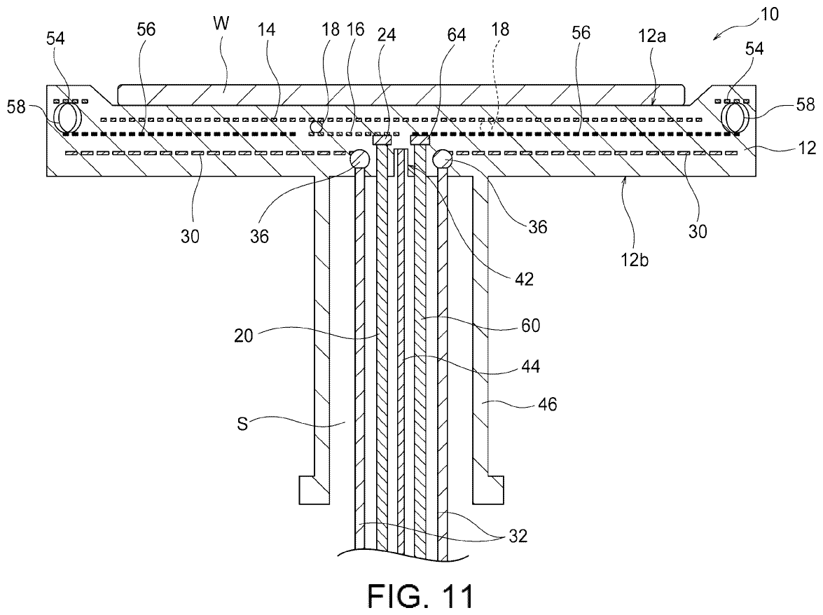

The first RF/ESC electrode 14 and the second RF/ESC electrode 16 may be the same electrode or different electrodes in terms of a material, a form, a shape, a size, and the like. The first RF/ESC electrode 14 and/or the second RF/ESC electrode 16 preferably contains at least one selected from the group consisting of tungsten, molybdenum, a tungsten-molybdenum alloy, tungsten carbide, a tungsten carbide-titanium nitride composite material, a tungsten carbide-aluminum oxide composite material, and niobium. Further, preferable form examples of each of the first RF/ESC electrode 14 and the second RF/ESC electrode 16 include a mesh, a perforated metal, a printed pattern, and a combination thereof. In a plan view, the first RF/ESC electrode 14 preferably has a disk shape. On the other hand, in a plan view, the second RF/ESC electrode 16 may have a disk shape, or a combined shape of an annular portion and a linear portion. In the combination of the annular portion and the linear portion, the linear portion is electrically connected to the RF/ESC rod 20, and the annular portion connected to the linear portion can supply power to the first RF/ESC electrode 14 (optionally through connection member 18), which makes it possible to realize a configuration high in space efficiency. In a plan view, the first RF/ESC electrode 14 and the second RF/ESC electrode 16 preferably have an equivalent size or an equivalent diameter as illustrated in FIGS. 5 and 8; however, as illustrated in FIGS. 2 and 11, the size or the diameter of the second RF/ESC electrode 16 may be made smaller than the size or the diameter of the first RF/ESC electrode 14, or the size or the diameter of the second RF/ESC electrode 16 may be made larger than the size or the diameter of the first RF/ESC electrode 14. In other words, since the functions as the RF/ESC electrode can be basically secured by the first RF/ESC electrode 14, the size of the second RF/ESC electrode 16 is not particularly limited as long as a desired power supply function can be secured.

The distance between the center line of the first RF/ESC electrode 14 and the center line of the second RF/ESC electrode 16 is 2 mm to 7 mm, preferably 3 mm to 6 mm, and more preferably 4 mm to 5 mm. When the distance is within such a range, the second RF/ESC electrode 16 is disposed at a position sufficiently deeper than the position of the first

RF/ESC electrode 14, and the RF/ESC terminal hole 22 can be made shallow (that is, hole bottom 22a can be brought closer to second surface 12b). As described above, this makes it possible to reduce stress concentration on the RF/ESC terminal hole 22, and the ceramic heater 10 can be made less likely to be broken. The distance between the center line of the first RF/ESC electrode 14 and the center line of the second RF/ESC electrode 16 means a separation distance between the center line that passes through a center in a thickness direction of the first RF/ESC electrode 14 and is in parallel with the first surface 12a and the center line that passes through a center in a thickness direction of the second RF/ESC electrode 16 and is in parallel with the first surface 12a in a case where the ceramic plate 12 is viewed in section.

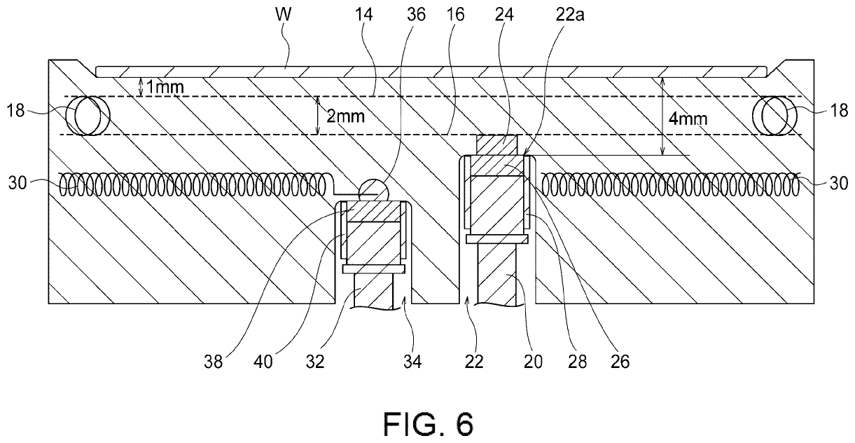

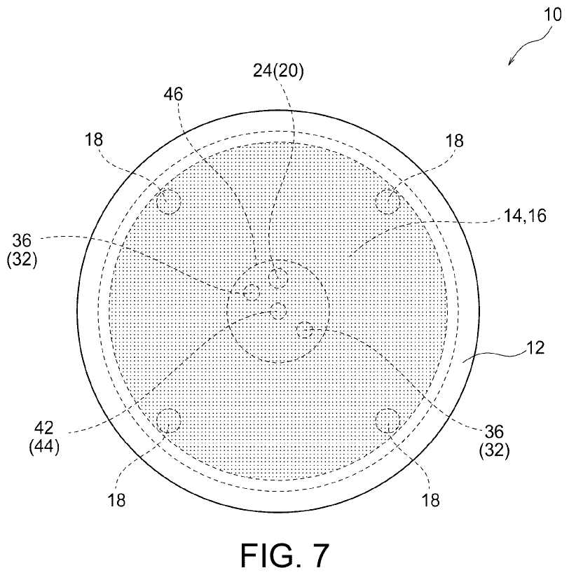

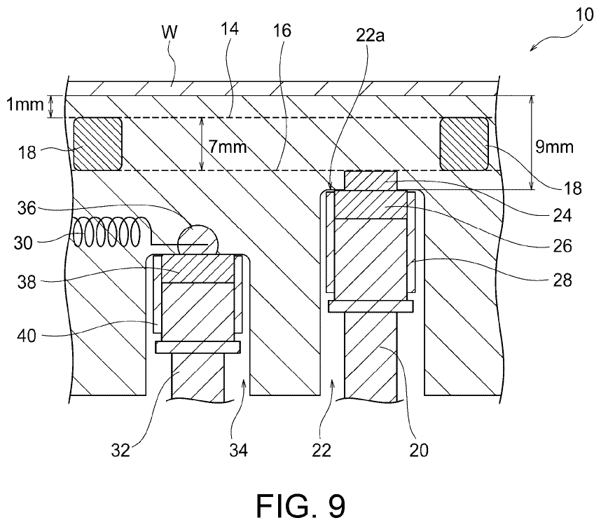

The connection member 18 that electrically connects the first RF/ESC electrode 14 and the second RF/ESC electrode 16 is preferably provided between the first RF/ESC electrode 14 and the second RF/ESC electrode 16. Using the connection member 18 makes it possible to easily and surely secure electric connection between the first RF/ESC electrode 14 and the second RF/ESC electrode 16 that are embedded at depth positions different from each other. Although the connection member 18 is not particularly limited as long as the connection member 18 is a member that can secure the electric connection between the first RF/ESC electrode 14 and the second RF/ESC electrode 16, the connection member 18 is preferably at least one selected from the group consisting of a coil, a metal tablet, and a metal mesh laminate. In a case where the connection member 18 is a coil, as illustrated in FIGS. 1 to 6 and 10 to 12, the coil is preferably disposed in a horizontal orientation such that a coil longitudinal direction extends along an outer periphery of the second RF/ESC electrode 16 in terms of increase in the number of contact points with the first RF/ESC electrode 14 and the second RF/ESC electrode 16, but a plurality of coils may be disposed in a vertical orientation. In a case where the connection member 18 is the metal tablet and/or the metal mesh laminate, as illustrated in FIGS. 7 to 9, a plurality of metal tablets and/or metal mesh laminates are preferably disposed so as to be positioned at an outer peripheral part of the second RF/ESC electrode 16. The metal tablet is a lump of metal, and the metal mesh laminate is formed by laminating a plurality of metal meshes. More preferably, the plurality of metal tablets and/or metal mesh laminates are separately disposed with equal intervals in an outer peripheral direction (for example, so as to be rotationally symmetric about center axis of ceramic plate 12). In any form, the connection member 18 preferably contains at least one selected from the group consisting of tungsten, molybdenum, a tungsten-molybdenum alloy, tungsten carbide, a tungsten carbide-titanium nitride composite material, a tungsten carbide-aluminum oxide composite material, and niobium.

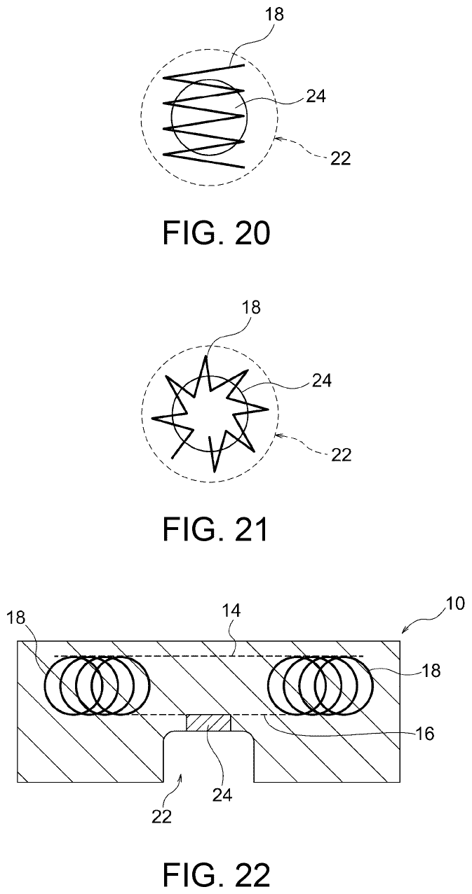

In a preferable aspect of the present disclosure, as illustrated in FIGS. 19 to 21, in a case where the ceramic plate 12 is viewed from above, the connection member 18 may be disposed at a position at least partially (that is, partially or entirely) overlapping with the RF/ESC terminal hole 22. In this aspect, as illustrated in FIG. 19, the connection member 18 is disposed above the RF/ESC terminal hole 22. This makes it possible to reduce a region occupied by the second RF/ESC electrode 16, and to realize a compact and simple configuration suitable for space saving. The connection member 18 may be disposed in any way as long as the connection member 18 can electrically connect the first RF/ESC electrode 14 and the second RF/ESC electrode 16. For example, as illustrated in FIG. 20, in the case where the ceramic plate 12 is viewed from above, the coil serving as the connection member 18 may be disposed in a direction crossing the RF/ESC terminal hole 22 or the embedded member 24 (for example, in diameter direction thereof). Alternatively, as illustrated in FIG. 21, the coil serving as the connection member 18 may be disposed such that a center axis of the coil extends in a direction (for example, circumferential direction) along an outer periphery of the RF/ESC terminal hole 22 or the embedded member 24.

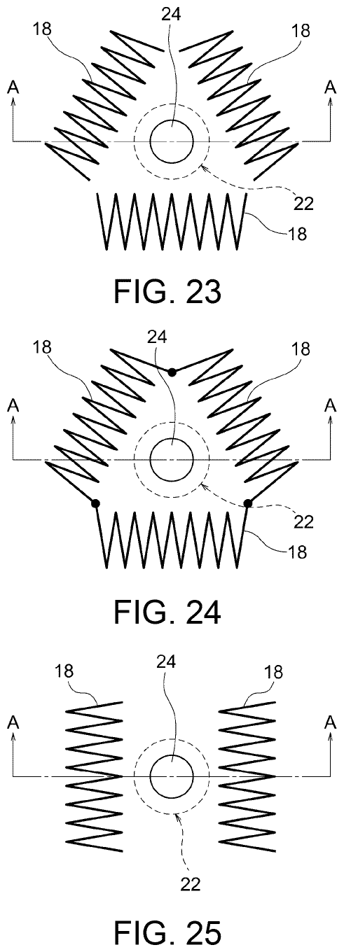

In another preferable aspect of the present disclosure, as illustrated in FIGS. 22 to 25, in the case where the ceramic plate 12 is viewed from above, the connection member 18 may be disposed at a position not overlapping with the RF/ESC terminal hole 22 (that is, position separated from RF/ESC terminal hole 22). In this aspect, as illustrated in FIG. 22, the connection member 18 is not disposed above the RF/ESC terminal hole 22. Therefore, soundness of the ceramic substrate above or in periphery of the RF/ESC terminal hole 22 that is easily broken due to stress concentration is easily secured, and a more robust configuration can be realized. The connection member 18 may be disposed in any way as long as the connection member 18 can electrically connect the first RF/ESC electrode 14 and the second RF/ESC electrode 16. For example, as illustrated in FIGS. 23 and 24, in the case where the ceramic plate 12 is viewed from above, the plurality of coils serving as the connection member 18 may be arranged in a polygonal shape so as to surround the RF/ESC terminal hole 22. In this case, the plurality of coils arranged in the polygonal shape may be separated from each other without coming into contact with each other as illustrated in FIG. 23, or may be connected to each other at end parts as illustrated in FIG. 24. As can be seen from FIG. 22, the connection member 18 secures electric connection between the first RF/ESC electrode 14 and the second RF/ESC electrode 16 in the thickness direction of the ceramic plate 12. Therefore, there is no problem even when the plurality of coils are separated from each other in the case where the ceramic plate 12 is viewed from above. The polygonal shape formed by the plurality of coils is not limited to a triangle in the illustrated example, and may be an optional polygonal shape such as a quadrilateral shape and a pentagonal shape. Alternatively, as illustrated in FIG. 25, in the case where the ceramic plate 12 is viewed from above, the plurality of coils serving as the connection member 18 may be disposed in parallel with each other such that the RF/ESC terminal hole 22 is positioned among the plurality of coils. In this case, the number of coils is not limited to two in the illustrated example, and may be an optional number such as three and four.

The RF/ESC terminal hole 22 is a bottomed hole into which the front end part of the RF/ESC rod 20 is inserted, and is provided in the thickness direction from the second surface 12b of the ceramic plate 12 toward the second RF/ESC electrode 16. The RF/ESC terminal hole 22 is not required to reach the second RF/ESC electrode 16 as long as the electric connection between the RF/ESC rod 20 and the second RF/ESC electrode 16 is secured. Preferably, the embedded member 24 is embedded between the hole bottom 22a of the RF/ESC terminal hole 22 and the second RF/ESC electrode 16 in the ceramic plate 12, and the embedded member 24 electrically connects the RF/ESC rod 20 and the second RF/ESC electrode 16. In this case, the RF/ESC terminal hole 22 is preferably provided so as to reach the embedded member 24 from the second surface 12b.

The distance from the first surface 12a to the hole bottom 22a of the RF/ESC terminal hole 22 is 4 mm to 9 mm, preferably 5 mm to 9 mm, and more preferably 6 mm to 9 mm. When the distance is within such a range, the RF/ESC terminal hole 22 is shallow (that is, hole bottom 22a is close to second surface 12b). As described above, this makes it possible to reduce stress concentration on the RF/ESC terminal hole 22, and the ceramic heater 10 can be made less likely to be broken. Although not particularly limited, the depth of the RF/ESC terminal hole 22 (distance from second surface 12b to hole bottom 22a) is typically 6 mm to 16 mm, more typically 8 mm to 13 mm, and further typically 8 mm to 11 mm or 11 mm to 13 mm.

The embedded member 24 is preferably a lump-shaped metal member for facilitating securement of electric connection with the second RF/ESC electrode 16 (for example, configured in mesh shape), and may be provided in contact with the second RF/ESC electrode 16. As a result, a sufficient contact area for brazing the RF/ESC rod 20 or the buffer 26 described below can be secured. Preferable examples of a metal configuring the embedded member 24 include Mo, W, and a W—Mo alloy, and Mo is preferable.

The buffer 26 may be provided between the hole bottom 22a of the RF/ESC terminal hole 22 and one of the second RF/ESC electrode 16 and the embedded member 24. The buffer 26 is a metal member provided as a buffer for reducing thermal expansion difference between the embedded member 24 and the RF/ESC rod 20, and is provided between the embedded member 24 and the RF/ESC rod 20. Preferable examples of a metal configuring the buffer 26 include an alloy such as Kovar® (Fe—Ni—Co alloy).

The eyelet 28 is a cylindrical member made of a metal, housed in or fitted to the RF/ESC terminal hole 22. The eyelet 28 has a function of guiding smooth insertion of the RF/ESC rod 20 into the RF/ESC terminal hole 22. The eyelet 28 may be threaded. In this case, the RF/ESC rod 20 is also threaded, and accordingly, the RF/ESC rod 20 can be inserted into the eyelet 28 while being engaged. Although not particularly limited, preferable examples of a metal configuring the eyelet 28 include Ni, W, Mo, and a W—Mo alloy, and Ni is preferable. Further, an outer periphery of the eyelet 28 may be male-threaded. Providing the threaded part makes it possible to engage the RF/ESC terminal hole 22 and the eyelet 28.

In a case where at least one selected from the embedded member 24, the buffer 26, and the eyelet 28 is used, the RF/ESC rod 20, the embedded member 24, the buffer 26 and/or the eyelet 28 are preferably brazed with each other.

The heater circuit 30 is embedded at a depth position closer to the second surface 12b than the second RF/ESC electrode 16 in the ceramic plate 12. Although not particularly limited, the heater circuit 30 may be obtained by, for example, arranging an electric conductive coil over the entire region of the ceramic plate 12 in a one-stroke pattern. The one-stroke pattern may be any of various well-known patterns such as alternation of progression and turnback, and a spiral shape. Heater rods 32 for power supply, inserted into heater terminal holes 34 are connected to respective ends of the heater circuit 30 (optionally through embedded members 36 and/or buffers 38 and/or eyelets 40), and the heater rods 32 are connected to heater power supplies (not illustrated) through an internal space S of a ceramic shaft 46. Each of the heater rods 32 may be configured such that one end is electrically connected to the heater circuit 30, and the other end extends from the second surface 12b. When power is supplied from the heater power supplies to the heater circuit 30, the heater circuit 30 generates heat, and heats the wafer W placed on the first surface 12a. The heater circuit 30 is not limited to the coil, and may be, for example, a ribbon (elongated thin plate), or a mesh. As the heater rods 32, the embedded members 36, the buffers 38, and the eyelets 40, those similar to the RF/ESC rod 20, the embedded member 24, the buffer 26, and the eyelet 28 are usable, respectively. In a case where at least ones selected from the embedded members 36, the buffers 38, and the eyelets 40 are used, each heater rod 32, and the embedded member 36, the buffer 38, and/or the eyelet 40 corresponding thereto are preferably brazed with each other.

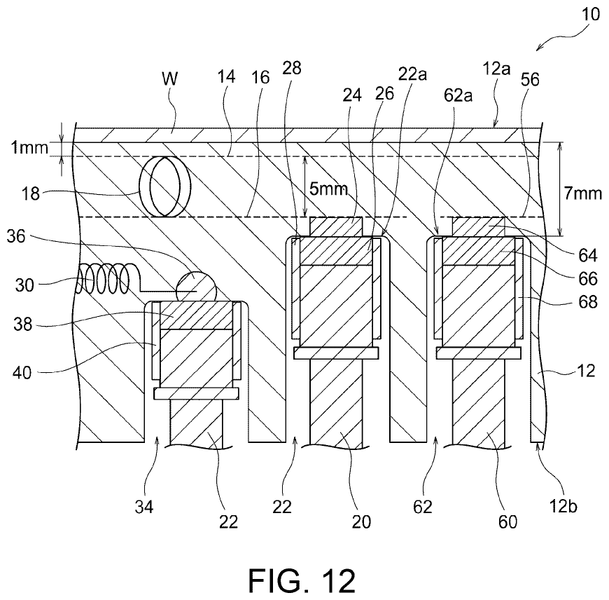

As illustrated in FIGS. 11 to 13, a third RF/ESC electrode 54 may be provided in the ceramic plate 12 separately from the RF/ESC electrode structure including the first RF/ESC electrode 14 and the second RF/ESC electrode 16. The RF/ESC electrode structure including the first RF/ESC electrode 14 and the second RF/ESC electrode 16 can cover the region of the ceramic plate 12 where the wafer W is placed (hereinafter, main region), but it is difficult for the RF/ESC electrode structure to cover the outer peripheral part (in particular, rising portion of first surface 12a) of the ceramic plate 12. Therefore, the third RF/ESC electrode 54 is separately provided on the outer peripheral part (in particular, rising portion of first surface 12a) of the ceramic plate 12, which makes it possible to exert desired RF and/or ESC functions on the outer peripheral part (in particular, rising portion). In this aspect, an outer-periphery RF/ESC electrode structure can be configured with a configuration following the main-region RF/ESC electrode structure. For example, the outer-periphery RF/ESC electrode structure may include the third RF/ESC electrode 54, a jumper 56, and a connection member 58. In a plan view, the third RF/ESC electrode 54 has an annular shape, and is embedded on the outer peripheral part (in particular, rising portion of first surface 12a) of the ceramic plate 12. In a plan view, the jumper 56 may have a linear shape or a combined shape of an annular portion and a linear portion. The connection member 58 electrically connects the third RF/ESC electrode 54 and the jumper 56. As illustrated in FIG. 12, it may be configured such that an RF/ESC rod 60 is inserted into an RF/ESC terminal hole 62, a linear jumper 56a electrically connected to the RF/ESC rod 60 (optionally through embedded member 64 and/or buffer 66 and or eyelet 68) is caused to extend in an outer peripheral direction and is connected to an annular jumper 56b, and the annular jumper 56b and the third RF/ESC electrode 54 are electrically connected through the connection member 58.

The third RF/ESC electrode 54 and/or the jumper 56 (for example, linear jumper 56a and annular jumper 56b) preferably contains at least one selected from the group consisting of tungsten, molybdenum, a tungsten-molybdenum alloy, tungsten carbide, a tungsten carbide-titanium nitride composite material, a tungsten carbide-aluminum oxide composite material, and niobium, as with the first RF/ESC electrode 14 and the second RF/ESC electrode 16. Although the connection member 58 is not particularly limited as long as the connection member 58 is a member that can secure the electric connection between the third RF/ESC electrode 54 and the jumper 56 as with the connection member 18, the connection member 58 is preferably at least one selected from the group consisting of a coil, a metal tablet, and a metal mesh laminate. Further, as with the connection member 18, the connection member 58 preferably contains at least one selected from the group consisting of tungsten, molybdenum, a tungsten-molybdenum alloy, tungsten carbide, a tungsten carbide-titanium nitride composite material, a tungsten carbide-aluminum oxide composite material, and niobium. Further, the RF/ESC rod 60, the embedded member 64, the buffer 66, and the eyelet 68 can have configurations similar to the RF/ESC rod 20, the embedded member 24, the buffer 26, and the eyelet 28 described above, respectively. In a case where at least one selected from the embedded member 64, the buffer 66, and the eyelet 68 is used, the RF/ESC rod 60, the embedded member 64, the buffer 66, and/or the eyelet 68 are preferably brazed with each other.

A temperature measurement hole 42 may be provided in the second surface 12b of the ceramic plate 12. The temperature measurement hole 42 may be a thermocouple hole for temperature measurement generally adopted in the ceramic heater. Therefore, a thermocouple 44 or a resistance temperature detector is inserted into the temperature measurement hole 42 to measure a temperature of the ceramic plate 12. The temperature measurement hole 42 may be a vertical hole, a horizontal hole, or a combination thereof, and may be formed so as to be suited to a region where a temperature is to be measured.

Optionally, the ceramic shaft 46 may be attached to the second surface 12b of the ceramic plate 12. The ceramic shaft 46 is a cylindrical member including the internal space S, and may have a configuration similar to a configuration of a ceramic shaft adopted in a well-known ceramic heater. The internal space S is configured to allow long members such as the RF/ESC rod 20, the heater rods 32, and the thermocouple 44 to pass therethrough. The ceramic shaft 46 is preferably made of a ceramic material similar to the material of the ceramic plate 12. Therefore, the ceramic shaft 46 preferably contains aluminum nitride or aluminum oxide, and more preferably contains aluminum nitride. An upper end surface of the ceramic shaft 46 is preferably bonded to the second surface 12b of the ceramic plate 12 by solid phase bonding or diffusion bonding. Although not particularly limited, an outer diameter of the ceramic shaft 46 is preferably 40 mm to 60 mm. Although not particularly limited, an inner diameter of the ceramic shaft 46 (diameter of internal space S) is preferably 33 mm to 55 mm.

### (Ceramic Heater According to Second Aspect)

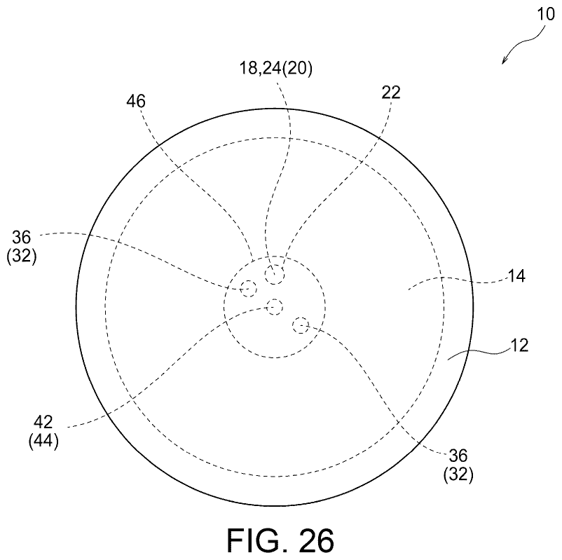

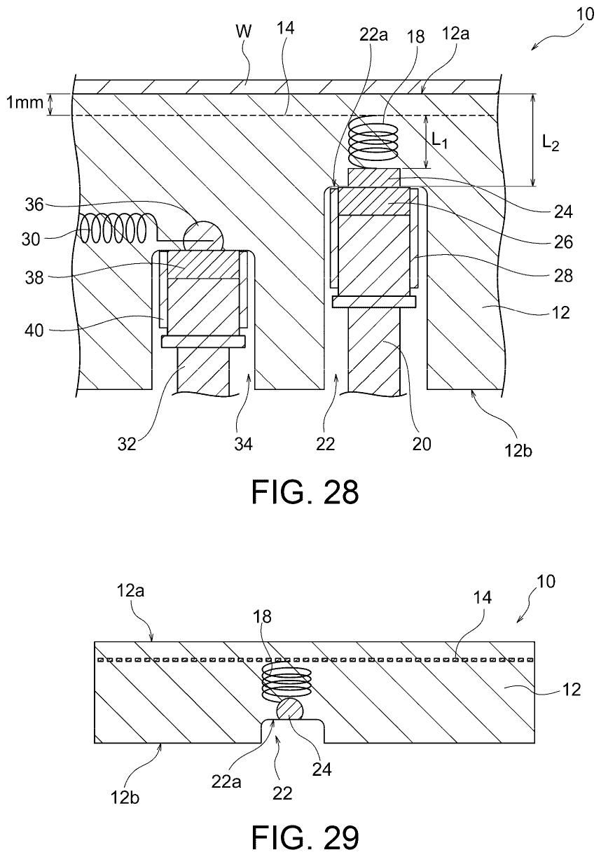

The ceramic heater according to the present invention may be a ceramic heater not including the second RF/ESC electrode. According to a second aspect of the present invention, the ceramic heater not including the second RF/ESC electrode is provided. FIGS. 26 to 28 illustrate one aspect of such a ceramic heater. The ceramic heater 10 illustrated in FIGS. 26 to 28 includes the ceramic plate 12, the first RF/ESC electrode 14, the embedded member 24, the connection member 18, the RF/ESC rod 20, the RF/ESC terminal hole 22, and the heater circuit 30. The ceramic plate 12 includes the first surface 12a on which the wafer W is placed, and the second surface 12b opposite to the first surface 12a. The first RF/ESC electrode 14 is embedded in the ceramic plate 12 in parallel with the first surface 12a. The embedded member 24 is embedded at a depth position farther from the first surface 12a than the first RF/ESC electrode 14 in the ceramic plate 12. The connection member 18 is embedded between the first RF/ESC electrode 14 and the embedded member 24 in the ceramic plate 12, and electrically connects the first RF/ESC electrode 14 and the embedded member 24. The RF/ESC rod 20 includes one end electrically connected to the embedded member 24, and the other end extending from the second surface 12b to the outside of the ceramic plate 12. The RF/ESC terminal hole 22 is a bottomed hole provided in the thickness direction from the second surface 12b of the ceramic plate 12 toward the embedded member 24, and the front end part of the RF/ESC rod 20 is inserted into the RF/ESC terminal hole 22. The heater circuit 30 is embedded at a depth position closer to the second surface 12b than the embedded member 24 in the ceramic plate 12. A separation distance L₁ between the first RF/ESC electrode 14 and the embedded member 24 is 1 mm to 7 mm. A distance L₂ from the first surface 12a to the hole bottom 22a of the RF/ESC terminal hole 22 is 2 mm to 16 mm. Thus, even in the case where the second RF/ESC electrode is not used, by (i) adopting the RF/ESC electrode structure including the first RF/ESC electrode 14 and the embedded member 24 that are electrically connected to each other through the connection member 18, (ii) setting the separation distance L₁ between the first RF/ESC electrode 14 and the embedded member 24 to 1 mm to 7 mm, and (iii) setting the distance L₂ from the first surface 12a of the ceramic plate 12 to the hole bottom 22a of the RF/ESC terminal hole 22 to 2 mm to 16 mm, it is possible to provide the ceramic heater 10 that has a relatively simple structure not including the second RF/ESC electrode and in which breakage attributable to center-cool temperature distribution is less likely to occur while functions of the RF/ESC electrode 14 are not impaired, as with the above-described ceramic heater according to the first aspect.

As described above, in the case where the plurality of terminals and terminal holes are collectively arranged at the center part of the ceramic plate on which the wafer is placed, when the ceramic heater has the center-cool temperature distribution, excessive tensile stress may occur on the terminal holes of the ceramic plate. In particular, stress easily concentrates on the RF/ESC terminal hole that is formed relatively deeper than the other terminal holes, and therefore, the ceramic heater is easily broken near the RF/ESC terminal hole. In other words, in the case of periphery-hot or center-cool temperature distribution, thermal expansion on a plate outer peripheral part is relatively greater than thermal expansion on a plate center part. Thus, tensile stress in a radius direction occurs in a form in which the plate outer periphery part pulls the plate center part, and the tensile stress is applied to the RF/ESC terminal hole positioned at the plate center part. As generally known, a stress concentration factor is increased as the hole is deeper. Therefore, stress easily concentrates on the RF/ESC terminal hole formed deep. In this regard, to avoid stress concentration, the RF/ESC terminal hole may be made shallow. In this case, however, a depth of the RF/ESC electrode from the wafer placement surface of the ceramic plate is increased (for example, from 1 mm to 3 mm). Thus, impedance is increased to largely adversely affect control of plasma by the RF electrode or to deteriorate a wafer catching function by the ESC electrode. The present invention successfully solves these problems. In the present invention, the RF/ESC electrode structure including the first RF/ESC electrode 14 and the embedded member 24 that are electrically connected to each other through the connection member 18 is adopted. In this structure, the first RF/ESC electrode 14 can be disposed at a shallow position near the first surface 12a as with the existing RF/ESC electrode, and the embedded member 24 (electrically connected to first RF/ESC electrode 14) is disposed at a position deeper than the position of the first RF/ESC electrode 14 (with first surface 12a as reference), which makes it possible to secure electric connection with the RF/ESC rod 20. In other words, the desired RF/ESC electrode function can be secured by the first RF/ESC electrode 14 as with the existing technique, and the embedded member 24 for electric connection is disposed at a deeper position, which makes it possible to make the RF/ESC terminal hole 22 shallower than an existing product (that is, hole bottom 22a of RF/ESC terminal hole 22 can be brought closer to second surface 12b). Stress is less likely to concentrate on the RF/ESC terminal hole 22 thus formed shallow, and accordingly, the ceramic heater 10 is less likely to be broken near the RF/ESC terminal hole 22.

The components of the ceramic heater 10 according to the second aspect are basically similar to the components of the ceramic heater 10 according to the first aspect. Therefore, description about various kinds of components such as the ceramic plate 12, the first RF/ESC electrode 14, the connection members 18 and 58, the RF/ESC rods 20 and 60, the RF/ESC terminal holes 22 and 62, the embedded members 24, 36, and 64, the buffers 26, 38, and 66, the eyelets 28, 40, and 68, the heater circuit 30, the heater rods 32, the temperature measurement hole 42, the thermocouple 44 (or resistance temperature detector), the ceramic shaft 46, the third RF/ESC electrode 54, and the jumper 56 in the first aspect is directly applicable to the second aspect except for description related to the second RF/ESC electrode and other specifications unique to the first aspect (arrangement, positions, dimensions, etc.). Therefore, description in the first aspect is basically applied to description of these components, and description in this section is minimized. Thus, a configuration unique to the second aspect is mainly described below.

In the second aspect, the separation distance L₁ between the first RF/ESC electrode 14 and the embedded member 24 is 1 mm to 7 mm, preferably 2 mm to 5 mm, and more preferably 2 mm to 3 mm. When the separation distance L₁ is within such a range, the embedded member 24 is disposed at a position sufficiently deeper than the position of the first RF/ESC electrode 14, and the RF/ESC terminal hole 22 can be made shallow (that is, hole bottom 22a can be brought closer to second surface 12b). As described above, this makes it possible to reduce stress concentration on the RF/ESC terminal hole 22, and the ceramic heater 10 can be made less likely to be broken. The separation distance L₁ between the first RF/ESC electrode 14 and the embedded member 24 means a shortest distance between a lower surface of the first RF/ESC electrode 14 and an upper surface of the embedded member 24. When the separation distance L₁ is large, a resistance is increased, and heat is locally generated.

In the second aspect, the RF/ESC terminal hole 22 is a bottomed hole into which the front end part of the RF/ESC rod 20 is inserted, and is provided in the thickness direction from the second surface 12b of the ceramic plate 12 toward the embedded member 24. The distance L₂ from the first surface 12a to the hole bottom 22a of the RF/ESC terminal hole 22 is 2 mm to 16 mm, and preferably 4 mm to 10 mm. When the distance L₂ is within such a range, the RF/ESC terminal hole 22 is shallow (that is, hole bottom 22a is close to second surface 12b). As described above, this makes it possible to reduce stress concentration on the RF/ESC terminal hole 22, and the ceramic heater 10 can be made less likely to be broken. Although not particularly limited, the depth of the RF/ESC terminal hole 22 (distance from second surface 12b to hole bottom 22a) is typically 3 mm to 25 mm.

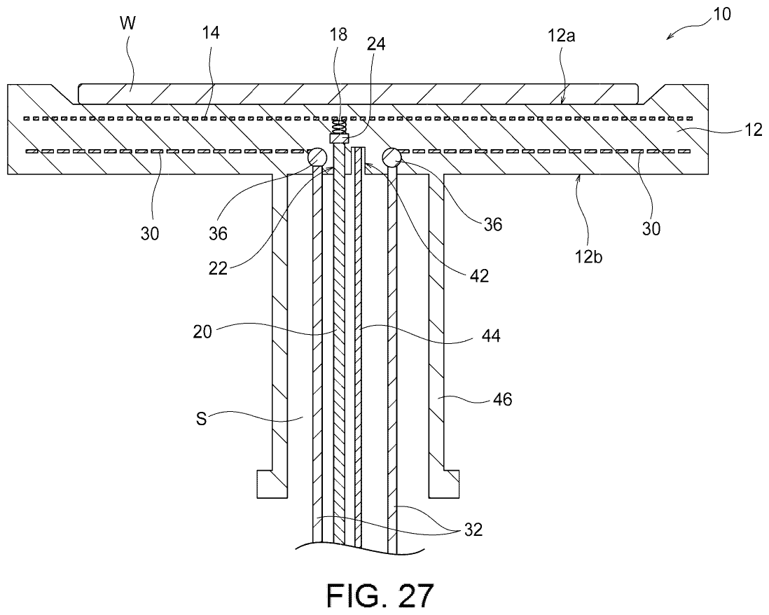

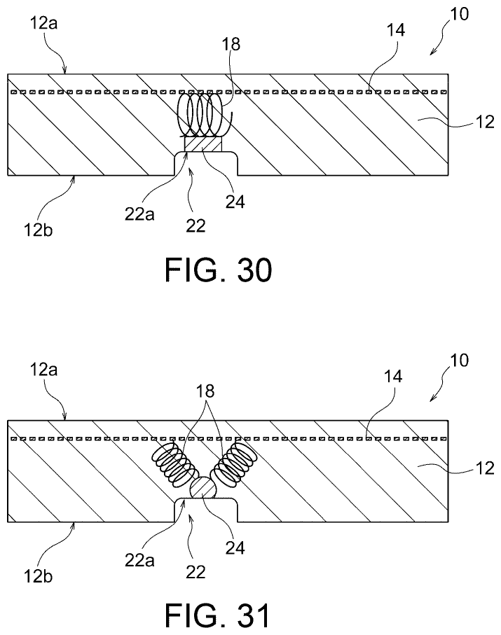

In the second aspect, although the connection member 18 is not particularly limited as long as the connection member 18 is a member that can secure the electric connection between the first RF/ESC electrode 14 and the embedded member 24, the connection member 18 is preferably at least one selected from the group consisting of a coil, a metal tablet, and a metal mesh laminate, and more preferably a coil. In the case where the connection member 18 is a coil, as illustrated in FIGS. 27 to 29, the coil may be disposed in a vertical orientation such that the coil longitudinal direction (center axis direction) is directed to the thickness direction (direction perpendicular to first surface 12a) of the ceramic plate 12, or as illustrated in FIG. 30, the coil may be disposed in a horizontal orientation such that the coil longitudinal direction (center axis direction) is directed to a direction (direction parallel to first surface 12a) perpendicular to the thickness of the ceramic plate 12. In any of the vertical orientation and the horizontal orientation, the second RF/ESC electrode is unnecessary, which makes it possible to realize a simple configuration. In the case where the coil is disposed in the vertical orientation, the connection member 18 is easily deformed in the vertical direction due to compression stress in the vertical direction applied in firing such as hot press. This provides advantages of reduction in remaining stress, and suppression of a crack of the ceramic plate. On the other hand, in the case where the coil is disposed in the horizontal orientation, a contact area with each of the first RF/ESC electrode 14 and the embedded member 24 can be increased. This provides an advantage of improvement in connection reliability between the first RF/ESC electrode 14 and the embedded member 24. Alternatively, as illustrated in FIG. 31, the coil may be disposed such that the coil longitudinal direction (center axis direction) is directed obliquely to the thickness direction of the ceramic plate 12. In the case of the oblique arrangement, a plurality of coils can be connected to one embedded member 24, and accordingly, a plurality of energization paths can be secured (that is, energization paths are distributed). This makes it possible to improve connection reliability between the first RF/ESC electrode 14 and the embedded member 24.

In the second aspect, the embedded member 24 is preferably a lump-shaped metal member for securing electric connection of the connection member 18, and is provided in contact with the connection member 18. As a result, a sufficient contact area for brazing the RF/ESC rod 20 or the buffer 26 described above can be secured. Preferable examples of a metal configuring the embedded member 24 include Mo, W, and a W—Mo alloy, and Mo is preferable. Although not particularly limited, a shape of the embedded member 24 is preferably a tablet shape as illustrated in FIGS. 27, 28, and 30, or a spherical shape as illustrated in FIGS. 29 and 31. The spherical embedded member 24 is not required to have a complete spherical shape, and may be a shape in which a part (for example, side exposed to RF/ESC terminal hole 22) is shaved off and processed to a flat shape. In the case where the plurality of coils are obliquely connected as illustrated in FIG. 31, the spherical embedded member 24 is advantageous in connection easiness irrespective of directions of the coils.

### EXAMPLES

The present invention is further specifically described using the following examples. However, the present invention is not limited to the following examples.

### Example A1

### (1) Fabrication of Ceramic Heater

The ceramic heater 10 that had the structure as illustrated in FIGS. 1 to 3 and satisfied conditions illustrated in Table 1 was fabricated using the components described below by a well-known procedure.

### <Components and Specifications Thereof>

Ceramic plate 12: disk-shaped aluminum nitride sintered body (diameter: 330 mm, thickness: 20 mm (including height of 1 mm of rising portion)) (first RF/ESC electrode 14, second RF/ESC electrode 16, connection member 18, embedded members 24 and 36, heater circuit 30, etc. are embedded therein)
First RF/ESC electrode 14: disk-shaped molybdenum electrode having diameter of 320 mm, embedded at depth position of 1.0 mm from first surface 12a of ceramic plate 12
Second RF/ESC electrode 16: plate-shaped molybdenum electrode having diameter of 95 mm, embedded at depth position of 5.0 mm from first surface 12a of ceramic plate 12
Connection member 18: coil made of molybdenum, disposed in horizontal orientation to cause coil longitudinal direction to extend along outer periphery of second RF/ESC electrode 16
RF/ESC rod 20: terminal rod made of nickel
RF/ESC terminal hole 22: bottomed hole having nominal diameter of 7 mm (M7) and depth of 13 mm (distance from first surface 12a to hole bottom 22a: 6 mm)
Embedded member 24: metal tablet made of molybdenum
Buffers 26 and 38: metal parts made of Kovar® (Fe—Ni—Co alloy)
Eyelets 28 and 40: cylindrical members made of nickel
Heater circuit 30: coil-shaped resistive heating element made of molybdenum, embedded at depth position of 10 mm from first surface 12a based on predetermined circuit pattern that can realize periphery-hot and center-cool temperature distribution
Heater rods 32: two terminal rods made of nickel
Heater terminal hole 34: bottomed hole having nominal diameter of 7 mm (M7) and depth of 7 mm
Embedded member 36: spherical member made of molybdenum
Ceramic shaft 46: cylindrical aluminum nitride sintered body (height: 172 mm, outer diameter: 42 mm, inner diameter: 36 mm)

### (2) Evaluation

Various kinds of evaluations were performed on an obtained ceramic heater.

### <Cycle Test>

The ceramic heater 10 was placed inside a chamber of a film forming apparatus. The chamber was vacuumed, N₂ gas was introduced to the chamber, and N₂ gas pressure inside the chamber was set to 5 Torr. Power was supplied to the heater circuit 30 through the heater rods 32, the buffer 38, and the embedded member 36, to heat the ceramic heater 10 from a room temperature (20° C.) to a set temperature of 550° C. At the set temperature, temperature distribution on the first surface 12a of the ceramic plate 12 was measured by an infrared camera, the power supplied to the heater circuit 30 was adjusted to realize a state (hereinafter, referred to as 25° C. center-cool state) where a temperature of an outer peripheral part of a wafer placement portion was higher by 25° C. at maximum than a center part at the set temperature (550° C.), and then, power supply was stopped and the ceramic heater 10 was left to be cooled to the room temperature (20° C.). At this time, a temperature rising speed was increased and a heat reflection ring was placed on the outer peripheral part of the ceramic heater 10 to facilitate realization of the 25° C. center-cool state. The cycle in which the ceramic heater was increased from 20° C. to 550° C. and then cooled to 20° C. was performed 100 times in total. Thereafter, presence/absence of a crack inside the ceramic plate 12 was checked by an ultrasonic flaw detection apparatus. As a result, as illustrated in Table 1, it was confirmed that a crack attributable to center-cool temperature distribution and temperature increase/decrease did not occur.

### <Stress Analysis>

The 25° C. center-cool state of the ceramic heater 10 at the set temperature of 550° C. was reproduced by computer simulation using commercially available analysis software Ansys (produced by ANSYS, Inc.), and thermal stress analysis was performed. Thermal stress near the RF/ESC terminal hole 22 obtained by the analysis was as illustrated in Table 1.

### Example A2

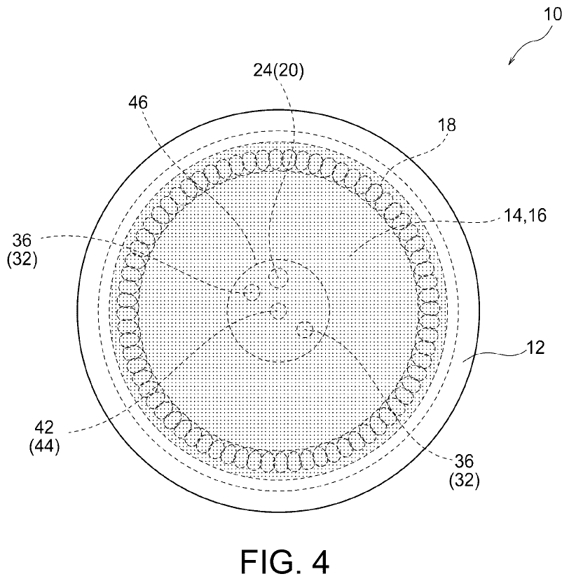

The ceramic heater 10 was fabricated by a well-known procedure in a manner similar to Example A1 except that the ceramic heater 10 had the structure as illustrated in FIGS. 4 to 6 and satisfied conditions illustrated in Table 1. More specifically, the ceramic heater 10 having a structure similar to the structure in Example A1 was fabricated except that (i) a disk-shaped molybdenum electrode having a diameter equivalent to the diameter of the first RF/ESC electrode 14, embedded at a depth position of 3.0 mm from the first surface 12a of the ceramic plate 12 was used as the second RF/ESC electrode 16, and (ii) a bottomed hole having a nominal diameter of 7 mm (M7) and a depth of 15 mm (distance from first surface 12a to hole bottom 22a: 4 mm) was formed as the RF/ESC terminal hole 22. Evaluation similar to the evaluation for Example A1 was performed on the fabricated ceramic heater 10. Results were as illustrated in Table 1.

### Example A3

The ceramic heater 10 was fabricated by a well-known procedure in a manner similar to Example A1 except that the ceramic heater 10 had the structure as illustrated in FIGS. 7 to 9 and satisfied conditions illustrated in Table 1. More specifically, the ceramic heater 10 having a structure similar to the structure in Example A1 was fabricated except that (i) a disk-shaped molybdenum electrode having a diameter equivalent to the diameter of the first RF/ESC electrode 14, embedded at a depth position of 8.0 mm from the first surface 12a of the ceramic plate 12 was used as the second RF/ESC electrode 16, (ii) a bottomed hole having a nominal diameter of 7 mm (M7) and a depth of 10 mm (distance from first surface 12a to hole bottom 22a: 9 mm) was formed as the RF/ESC terminal hole 22, and (iii) as the connection member 18, in place of the coil, four laminates each obtained by laminating a plurality of molybdenum meshes were rotationally-symmetrically arranged at equal intervals along an outer periphery of the second RF/ESC electrode 16. Evaluation similar to the evaluation for Example A1 was performed on the fabricated ceramic heater 10. Results were as illustrated in Table 1.

### Example A4

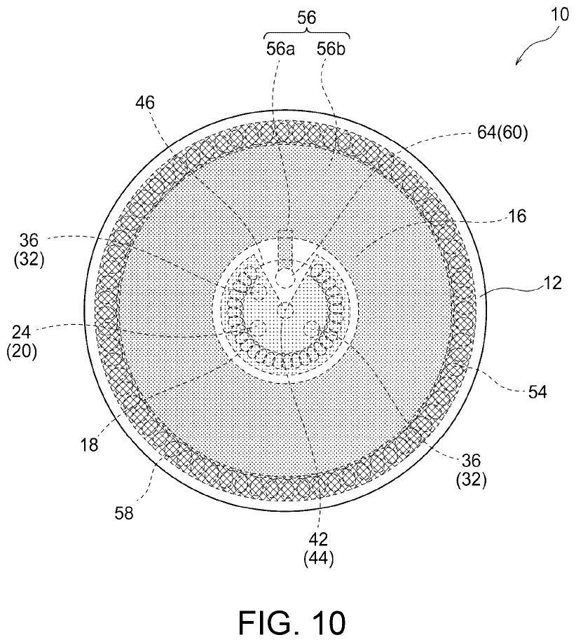

The ceramic heater 10 was fabricated by a well-known procedure in a manner similar to Example A1 except that the ceramic heater 10 had the structure as illustrated in FIGS. 10 to 12 and satisfied conditions illustrated in Table 1, and the thickness of the ceramic plate 12 was set to 21 mm (including height of 2 mm of rising portion). More specifically, the ceramic heater 10 having a structure similar to the structure in Example A1 was fabricated except that (i) the thickness of the ceramic plate 12 was set to 21 mm, (ii) a disk-shaped molybdenum electrode having a diameter of 80 mm, embedded at a depth position of 6.0 mm from the first surface 12a of the ceramic plate 12 was used as the second RF/ESC electrode 16, (iii) a bottomed hole having a nominal diameter of 7 mm (M7) and a depth of 12 mm (distance from first surface 12a to hole bottom 22a: 7 mm) was formed as the RF/ESC terminal hole 22, and (iv) the outer-periphery RF/ESC electrode structure including the annular third RF/ESC electrode 54, the jumper 56, and the connection member 58 was embedded such that the third RF/ESC electrode 54 is disposed in the rising portion of the outer peripheral part of the ceramic plate 12, and the RF/ESC terminal hole 62, the embedded member 64, the RF/ESC rod 60, the buffer 66, and the eyelet 68 were additionally provided.

At this time, the ceramic heater 10 was configured such that the linear jumper 56a electrically connected to the RF/ESC rod 60 inserted into the RF/ESC terminal hole 62 through the embedded member 64 and the buffer 66 was caused to extend in the outer peripheral direction and was connected to the annular jumper 56b, and the annular jumper 56b and the third RF/ESC electrode 54 were electrically connected through the connection member 58. Specifications of the components added in this example are as follows.

### Additional Components and Specifications Thereof

Third RF/ESC electrode 54: annular molybdenum electrode embedded at depth position of 1.0 mm from first surface 12a in rising portion of ceramic plate 12
Linear jumper 56a: linear molybdenum layer embedded at depth position of 6.0 mm from first surface 12a of ceramic plate 12
Annular jumper 56b: annular molybdenum layer embedded at depth position of 6.0 mm from first surface 12a of ceramic plate 12 and connected to linear jumper 56a
Connection member 58: coil made of molybdenum, disposed in horizontal orientation to cause coil longitudinal direction to extend along outer periphery of annular jumper 56b
RF/ESC rod 60: terminal rod made of nickel
RF/ESC terminal hole 62: nominal diameter of 7 mm (M7), and depth of 12 mm (distance from first surface 12a to hole bottom 62a: 7 mm)
Embedded member 64: metal tablet made of molybdenum
Buffer 66: metal part made of Kovar® (Fe—Ni—Co alloy)
Eyelet 68: cylindrical member made of nickel

Evaluation similar to the evaluation for Example A1 was performed on the fabricated ceramic heater 10. Results were as illustrated in Table 1.

### Example A5 (Comparison)

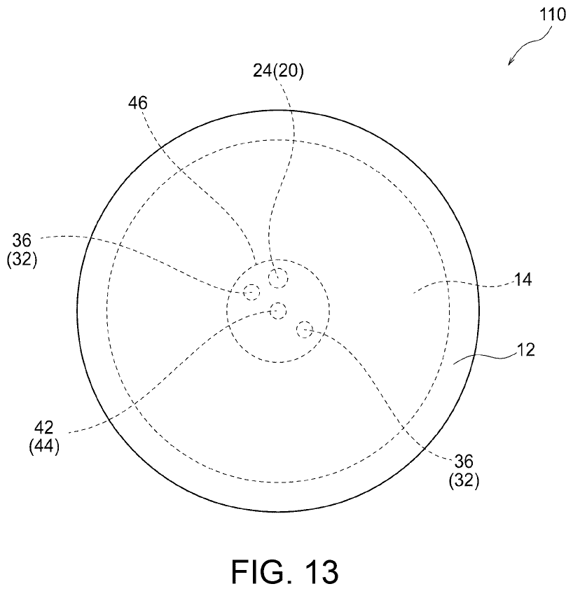

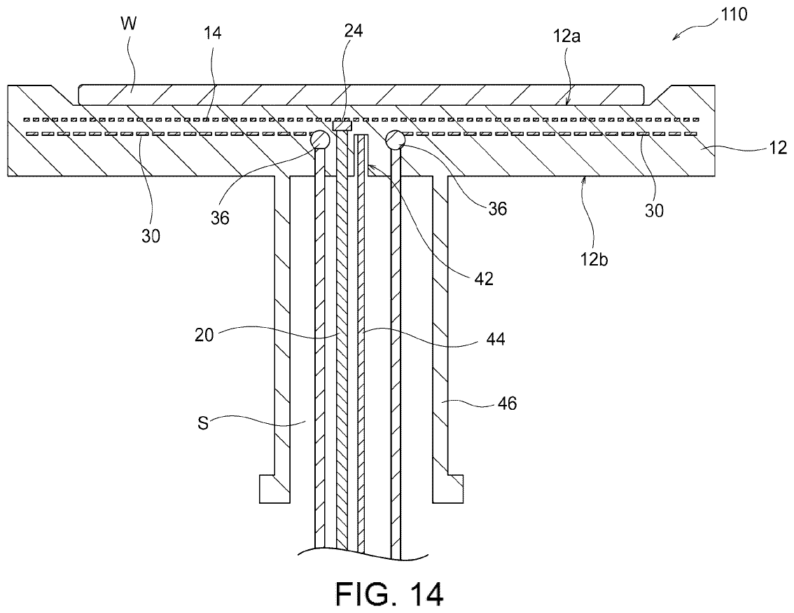

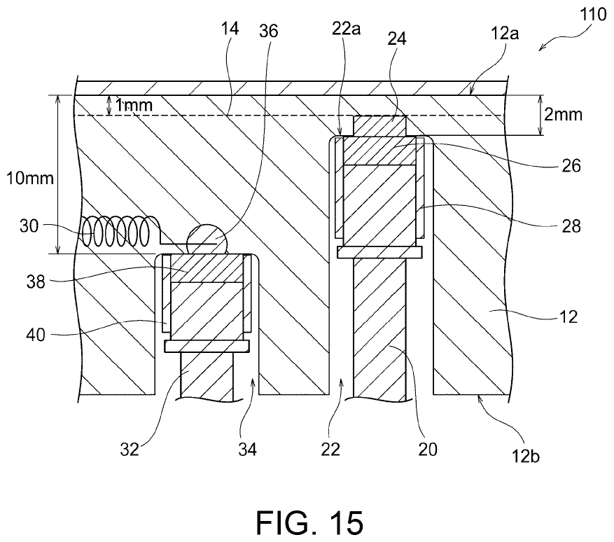

An existing ceramic heater 110 was fabricated by a well-known procedure in a manner similar to Example A1 except that the ceramic heater 110 had the structure as illustrated in FIGS. 13 to 15 and satisfied conditions illustrated in Table 1. More specifically, the ceramic heater 110 having a structure similar to the structure in Example A1 was fabricated except that (i) the second RF/ESC electrode 16 and the connection member 18 were eliminated, and (ii) a bottomed hole having a nominal diameter of 7 mm (M7) and a depth of 17 mm (distance from first surface 12a to hole bottom 22a: 2 mm) was formed as the RF/ESC terminal hole 22. Evaluation similar to the evaluation for Example A1 was performed on the fabricated existing ceramic heater 110. Results were as illustrated in Table 1.

### Example A6 (Comparison)

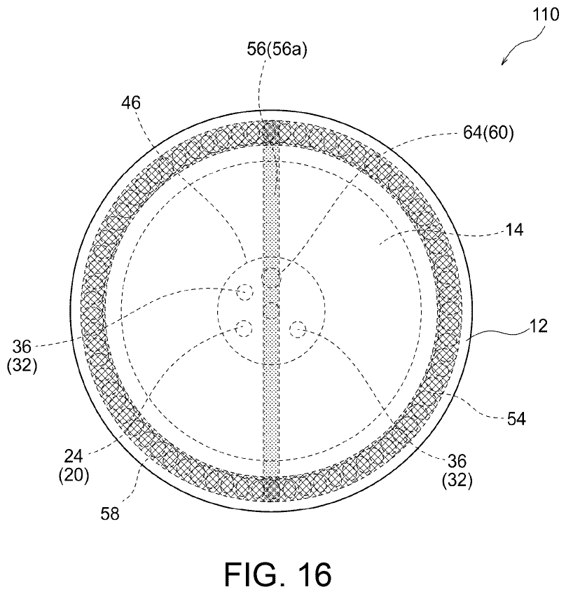

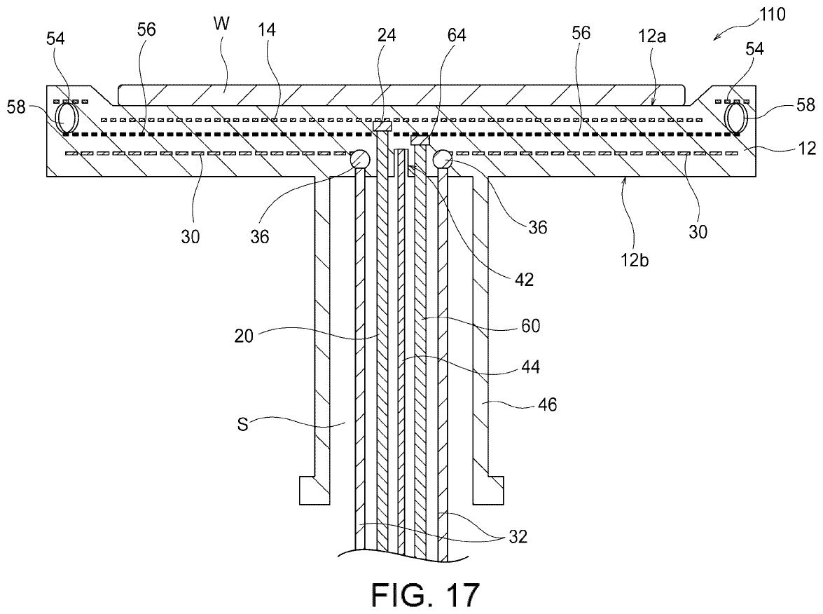

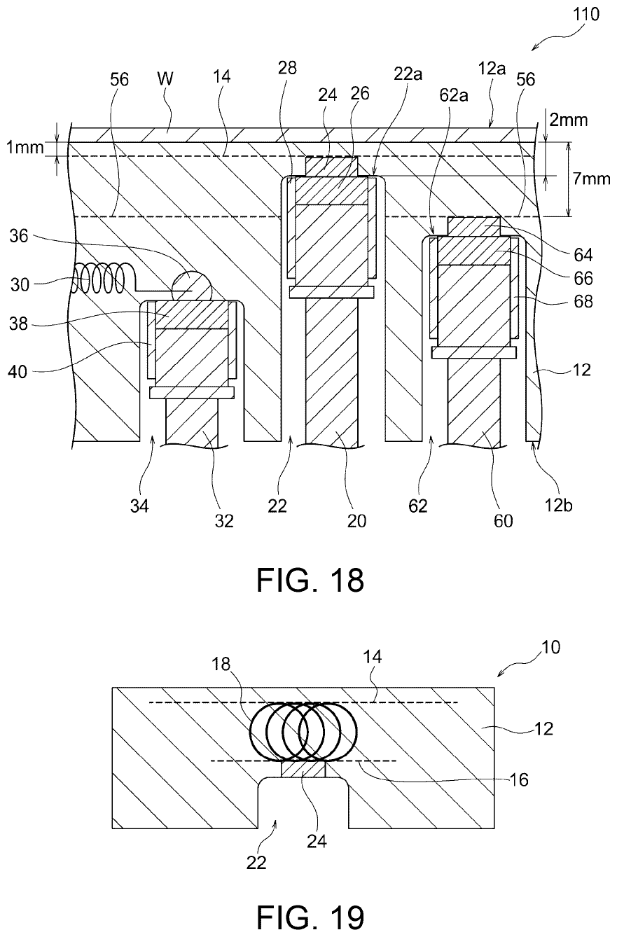

An existing ceramic heater 110 was fabricated by a well-known procedure in a manner similar to Example A4 except that the ceramic heater 110 had the structure as illustrated in FIGS. 16 to 18 and satisfied conditions illustrated in Table 1, and the thickness of the ceramic plate 12 was set to 20 mm (including height of 1 mm of rising portion). More specifically, the ceramic heater 110 having a structure similar to the structure in Example A4 was fabricated except that (i) the thickness of the ceramic plate 12 was set to 20 mm, (ii) the second RF/ESC electrode 16 and the connection member 18 were eliminated, (iii) a bottomed hole having a nominal diameter of 7 mm (M7) and a depth of 17 mm (distance from first surface 12a to hole bottom 22a: 2 mm) was formed as the RF/ESC terminal hole 22, and (iv) the jumper 56 was configured only by the belt-shaped linear jumper 56a, was caused to linearly extend from the embedded member 64 in two directions opposite to each other, and was electrically connected to the third RF/ESC electrode 54 through the connection member 58. Evaluation similar to the evaluation for Example A1 was performed on the fabricated existing ceramic heater 110. Results were as illustrated in Table 1.

TABLE 1

| | | | | | Outer-periphery RF/ESC | Evaluation | |
|---|---|---|---|---|---|---|---|
| | Main-region RF/ESC electrode structure | | | | electrode structure | (25° C. center-cool state) | |
| | Presence/ | Presence/ | | Distance between | Presence/absence of third | Occurrence of | |
| | absence of | absence of | Distance from | center line of first | RF/ESC electrode 54 and | crack during | |
| | second RF/ | connection | first surface 12a | RF/ESC electrode | distance from first | temperature | Thermal stress |
| | ESC electrode | member 18 | to hole bottom | 14 and center line | surface 12a to hole | increase/ | in RF/ESC |
| | 16 and form | and form | 22a of RF/ESC | of second RF/ESC | bottom 62a of RF/ESC | reduction | terminal hole 22 |
| | thereof | thereof | terminal hole 22 | electrode 16 | terminal hole 62 | in cycle test | (tensile stress) |
| Example A1 | Present | Present | 6 mm | 4 mm | Absent | Absent | 67 MPa |
| | (disk shape) | (coil shape) | | | | | |
| Example A2 | Present | Present | 4 mm | 2 mm | Absent | Absent | 69 MPa |
| | (disk shape) | (coil shape) | | | | | |
| Example A3 | Present | Present | 9 mm | 7 mm | Absent | Absent | 63 MPa |
| | (disk shape) | (metal mesh | | | | | |
| | | laminate) | | | | | |
| Example A4 | Present | Present | 7 mm | 5 mm | Present | Absent | 65 MPa |
| | (disk shape) | (coil shape) | | | (7 mm) | | |
| Example A5* | Absent | Absent | 2 mm | — | Absent | Present | 83 MPa |
| Example A6* | Absent | Absent | 2 mm | — | Present | Present | 84 MPa |
| | | | | | (7 mm) | | (value related |
| | | | | | | | to RF/ESC |
| | | | | | | | terminal hole |
| | | | | | | | 22) |

*Comparative example

### Examples B1 to B8

### (1) Fabrication of Ceramic Heater

The ceramic heater 10 that had the structure illustrated in FIGS. 26 to 28 and satisfied conditions illustrated in Table 2 was fabricated using the components described below by a well-known procedure.

### Components and Specifications Thereof

Ceramic plate 12: disk-shaped aluminum nitride sintered body (diameter: 330 mm, thickness: 20 mm (including height of 1 mm of rising portion)) (first RF/ESC electrode 14, connection member 18, embedded members 24 and 36, heater circuit 30, etc. are embedded therein)
First RF/ESC electrode 14: disk-shaped molybdenum electrode having diameter of 320 mm, embedded at depth position of 1.0 mm from first surface 12a of ceramic plate 12
Connection member 18: coil made of molybdenum, disposed in vertical orientation to cause coil longitudinal direction (center axis direction) to be directed to thickness direction of ceramic plate 12
RF/ESC rod 20: terminal rod made of nickel
RF/ESC terminal hole 22: bottomed hole having nominal diameter of 7 mm (M7) (distance L₂ from first surface 12a to hole bottom 22a: as illustrated in Table 2)
Embedded member 24: metal tablet made of molybdenum (separation distance L₁ between first RF/ESC electrode 14 and embedded member 24: as illustrated in Table 2)
Buffers 26 and 38: metal parts made of Kovar® (Fe—Ni—Co alloy)
Eyelets 28 and 40: cylindrical members made of nickel
Heater circuit 30: coil-shaped resistive heating element made of molybdenum, embedded at depth position of 10 mm from first surface 12a based on predetermined circuit pattern that can realize periphery-hot and center-cool temperature distribution
Heater rods 32: two terminal rods made of nickel
Heater terminal hole 34: bottomed hole having nominal diameter of 7 mm (M7) and depth of 7 mm
Embedded member 36: spherical member made of molybdenum
Ceramic shaft 46: cylindrical aluminum nitride sintered body (height: 172 mm, outer diameter: 42 mm, inner diameter: 36 mm)

### (2) Evaluation

Cycle test evaluation was performed on the obtained ceramic heater in a manner similar to Examples A1 to A6. Results were as illustrated in Table 2. In Examples B1 to B7, occurrence of a crack was not observed in the cycle test, whereas in Example B8 that did not satisfy requirement of the second aspect, occurrence of a crack was observed. In Example B7 that did not satisfy requirement of the second aspect, occurrence of a crack was not observed, but it was found that there was a high possibility that the coil was deviated and connected because the distances L₁ and L₂ were excessively long.

TABLE 2

| | Separation distance | Distance L₂ | Occurrence of |
|---|---|---|---|
| | L₁ between | from first surface | crack during |
| | first RF/ESC elec- | 12a to hole | temperature |
| | trode 14 and upper | bottom 22a | increase/ |
| | surface of embedded | of RF/ESC | decrease |
| | member 24 | terminal hole 22 | in cycle test |
| Example B1 | 1 | 2 | Absent |
| Example B2 | 2 | 5 | Absent |
| Example B3 | 3 | 7 | Absent |
| Example B4 | 5 | 10 | Absent |
| Example B5 | 5 | 12 | Absent |
| Example B6 | 7 | 16 | Absent |
| Example B7* | 9 | 20 | Absent |
| Example B8* | 0.5 | 1 | Present |

*Comparative example

### REFERENCE SIGNS LIST

10 Ceramic Heater
12 Ceramic Plate
12a First surface
12b Second surface
14 First RF/ESC electrode
16 Second RF/ESC electrode
18, 58 Connection member
20, 60 RF/ESC rod
22, 62 RF/ESC terminal hole
22a, 62a Hole bottom
24, 36, 64 Embedded member
26, 38, 66 Buffer
28, 40, 68 Eyelet
30 Heater circuit
32 Heater rod
34 Heater terminal hole
42 Temperature measurement hole
44 Thermocouple
46 Ceramic shaft
54 Third RF/ESC electrode
56 Jumper
56a Linear jumper
56b Annular jumper
W Wafer
S Internal space

What is claimed is:

1. A ceramic heater, comprising:
a ceramic plate including a first surface on which a wafer is to be placed, and a second surface opposite to the first surface;
a first RF/ESC electrode embedded in the ceramic plate in parallel with the first surface;
a second RF/ESC electrode electrically connected to the first RF/ESC electrode, and embedded at a depth position farther from the first surface than the first RF/ESC electrode in the ceramic plate in parallel with the first surface;
an RF/ESC rod including one end electrically connected to the second RF/ESC electrode, and another end extending from the second surface to an outside of the ceramic plate;
an RF/ESC terminal hole into which a front end part of the RF/ESC rod is inserted, the RF/ESC terminal hole being a bottomed hole provided in a thickness direction from the second surface of the ceramic plate toward the second RF/ESC electrode; and
a heater circuit embedded at a depth position closer to the second surface than the second RF/ESC electrode in the ceramic plate,
wherein a distance between a center line of the first RF/ESC electrode and a center line of the second RF/ESC electrode is 2 mm to 7 mm,
wherein a distance from the first surface to a hole bottom of the RF/ESC terminal hole is 4 mm to 9 mm, and
wherein the ceramic heater further comprises a ceramic shaft attached to the second surface of the ceramic plate and having a cylindrical shape including an internal space.

2. A ceramic heater, comprising:
a ceramic plate including a first surface on which a wafer is to be placed, and a second surface opposite to the first surface;
a first RF/ESC electrode embedded in the ceramic plate in parallel with the first surface;
an embedded member embedded at a depth position farther from the first surface than the first RF/ESC electrode in the ceramic plate;
a connection member embedded between the first RF/ESC electrode and the embedded member in the ceramic plate, and configured to electrically connect the first RF/ESC electrode and the embedded member;
an RF/ESC rod including one end electrically connected to the embedded member, and another end extending from the second surface to an outside of the ceramic plate;
an RF/ESC terminal hole into which a front end part of the RF/ESC rod is inserted, the RF/ESC terminal hole being a bottomed hole provided in a thickness direction from the second surface of the ceramic plate toward the embedded member; and
a heater circuit embedded at a depth position closer to the second surface than the embedded member in the ceramic plate,
wherein a separation distance between the first RF/ESC electrode and the embedded member is 1 mm to 7 mm, and
wherein a distance from the first surface to a hole bottom of the RF/ESC terminal hole is 2 mm to 16 mm.

3. The ceramic heater according to claim 1, further comprising a connection member configured to electrically connect the first RF/ESC electrode and the second RF/ESC electrode, between the first RF/ESC electrode and the second RF/ESC electrode in the ceramic plate.

4. The ceramic heater according to claim 2, wherein the connection member is at least one selected from the group consisting of a coil, a metal tablet, and a metal mesh laminate.

5. The ceramic heater according to claim 1 wherein the ceramic plate contains aluminum nitride or aluminum oxide.

6. The ceramic heater according to claim 1, wherein the first RF/ESC electrode and/or the second RF/ESC electrode contains at least one selected from the group consisting of tungsten, molybdenum, a tungsten-molybdenum alloy, tungsten carbide, a tungsten carbide-titanium nitride composite material, a tungsten carbide-aluminum oxide composite material, and niobium.

7. The ceramic heater according to claim 2, wherein the first RF/ESC electrode contains at least one selected from the group consisting of tungsten, molybdenum, a tungsten-molybdenum alloy, tungsten carbide, a tungsten carbide-titanium nitride composite material, a tungsten carbide-aluminum oxide composite material, and niobium.

8. The ceramic heater according to claim 2, wherein the connection member contains at least one selected from the group consisting of tungsten, molybdenum, a tungsten-molybdenum alloy, tungsten carbide, a tungsten carbide-titanium nitride composite material, a tungsten carbide-aluminum oxide composite material, and niobium.

9. The ceramic heater according to claim 2, wherein when the ceramic plate is viewed from above, the connection member is disposed at a position at least partially overlapping with the RF/ESC terminal hole.

10. The ceramic heater according to claim 2, wherein when the ceramic plate is viewed from above, the connection member is disposed at a position not overlapping with the RF/ESC terminal hole.

11. The ceramic heater according to claim 2, further comprising a ceramic shaft attached to the second surface of the ceramic plate and having a cylindrical shape including an internal space.

12. The ceramic heater according to claim 1, wherein, in a plan view, the first RF/ESC electrode has a disk shape, and the second RF/ESC electrode has a disk shape or a combined shape of an annular portion and a linear portion.

13. The ceramic heater according to claim 1, wherein each of the first RF/ESC electrode and the second RF/ESC electrode has at least one form selected from the group consisting of a mesh, a perforated metal, and a printed pattern.

14. The ceramic heater according to claim 1, further comprising a heater rod including one end electrically connected to the heater circuit, and another end extending from the second surface to the outside of the ceramic plate.

15. The ceramic heater according to claim 1, further comprising an embedded member embedded between the hole bottom of the RF/ESC terminal hole and the second RF/ESC electrode in the ceramic plate, and configured to electrically connect the RF/ESC rod and the second RF/ESC electrode.
